(19) United States
(12) Patent Application Publication
(10) Pub. No.: US 2015/0305331 A1
(43) Pub. Date: Oct. 29, 2015

(54) PESTICIDAL MIXTURES COMPRISING JASMONIC ACID OR A DERIVATIVE THEREOF

(71) Applicant: BASF SE, Ludwigshafen (DE)

(72) Inventor: Markus Gewehr, Kastellaun (DE)

(73) Assignee: BASF SE, Ludwigshafen (DE)

(21) Appl. No.: 14/432,503

(22) PCT Filed: Sep. 27, 2013
(86) PCT No.: PCT/EP2013/070149

§ 371 Date: Mar. 31, 2015

Related U.S. Application Data
(60) Provisional application No. 61/708,065, filed on Oct. 1, 2012.

(30) Foreign Application Priority Data
Nov. 8, 2012 (EP) 12191844.5

(51) Int. Cl. A01N 37/42; A01N 47/24

(52) U.S. Cl. CPC A01N 37/42; A01N 47/24

(57) ABSTRACT

The present invention relates to mixtures comprising as active components, one fungicidal compound IA or one insecticidal compound or one antifungal biocontrol agents and plant bioactivators IC and one compound II selected from jasmonic acid, salts or derivatives thereof.

The present invention relates to synergistic mixtures comprising as active components,
1) one fungicidal compound IA selected from the group consisting of
   A) Respiration inhibitors
      Inhibitors of complex III at Qₒ site (e.g. strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, mandestrobine, metominostrobin, orysastrobin, picoxystrobin, pyraclostrobin, pyrametostrobin, pyraoxystrobin, trifloxystrobin and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, fenamidone;
      inhibitors of complex III at Qᵢ site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate; (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate
      inhibitors of complex II (e. g. carboxamides): benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, 3-(difluoromethyl)-1-methyl-N-(1,1,3-trimethyl-indan-4-yl)pyrazole-4-carboxamide, 3-(trifluoromethyl)-1-methyl-N-(1,1,3-trimethyl-indan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)-pyrazole-4-carboxamide, 1,3,5-trimethyl-N-(1,1,3-trimethylindan-4-yl)pyrazole-4-carboxamide, N-(7-fluoro-1,1,3-trimethyl-indan-4-yl)-1,3-dimethyl-pyrazole-4-carboxamide, N-[2-(2,4-dichlorophenyl)-2-methoxy-1-methyl-ethyl]-3-(difluoromethyl)-1-methyl-pyrazole-4-carboxamide;
      other respiration inhibitors (e.g. complex I, uncouplers): diflumetorim, (5,8-difluoroquinazolin-4-yl)-{2-[2-fluoro-4-(4-trifluoromethyl pyridin-2-yloxy)-phenyl]-ethyl}-amine; nitrophenyl derivates: binapacryl, dinobuton, dinocap, fluazinam; ferimzone; organometal compounds: fentin salts, such as fentin-acetate, fentin chloride or fentin hydroxide; ametoctradin; and silthiofam;
   B) Sterol biosynthesis inhibitors (SBI fungicides)
      C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-[rel-(2S; 3R)-3-(2-chlorophenyl)-2-(2,4-difluorophenyl)-oxiranylmethyl]-5-thio-cyanato-1H-[1,2,4]triazole, 2-[rel-(2S; 3R)-3-(2-chlorophenyl)-2-(2,4-difluorophenyl)-oxiranylmethyl]-2H-[1,2,4]triazole-3-thiol, 2-[2-chloro-4-(4-chlorophenoxyl)phenyl]-1-(1,2,4-triazol-1-yl)pentan-2-ol, 1-[4-(4-chlorophenoxy)-2-(trifluoromethyl)phenyl]-1-cyclopropyl-2-(1,2,4-triazol-1-yl)ethanol, 2-[4-(4-chlorophenoxy)-2-(trifluoromethyl)phenyl]-1-(1,2,4-triazol-1-yl)butan-2-ol, 2-[2-chloro-4-(4-chlorophenoxyl)phenyl]-1-(1,2,4-triazol-1-yl)butan-2-ol, 2-[4-(4-chlorophenoxy)-2-(trifluoromethyl)phenyl]-3-methyl-1-(1,2,4-triazol-1-yl)butan-2-ol, 2-[4-(4-chlorophenoxy)-2-(trifluoromethyl)-phenyl]-1-(1,2,4-triazol-1-yl)propan-2-ol, 2-[2-chloro-4-(4-chlorophenoxyl)phenyl]-3-methyl-1-(1,2,4-triazol-1-yl)butan-2-ol, 2-[4-(4-chlorophenoxy)-2-(trifluoromethyl)-phenyl]-1-(1,2,4-triazol-1-yl)pentan-2-ol, 2-[4-(4-fluorophenoxy)-2-(trifluoromethyl)-phenyl]-1-(1,2,4-triazol-1-yl)propan-2-ol; imidazoles: imazalil, pefurazoate, prochloraz, triflumizol; pyrimidines, pyridines and piperazines: fenarimol, nuarimol, pyrifenox, triforine, [3-(4-chloro-2-fluoro-phenyl)-5-(2,4-difluorophenyl)isoxazol-4-yl]-(3-pyridyl)methanol;
      Delta14-reductase inhibitors: aldimorph, dodemorph, dodemorph-acetate, fenpropimorph, tridemorph, fenpropidin, piperalin, spiroxamine;
      Inhibitors of 3-keto reductase: fenhexamid;
   C) Nucleic acid synthesis inhibitors
      phenylamides or acyl amino acid fungicides: benalaxyl, benalaxyl-M, kiralaxyl, metalaxyl, metalaxyl-M (mefenoxam), ofurace, oxadixyl;
      others: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxyl)pyrimidin-4-amine;
   D) Inhibitors of cell division and cytoskeleton
      tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine
      other cell division inhibitors: diethofencarb, ethaboxam, pencycuron, fluopicolide, zoxamide, metrafenone, pyriofenone;
   E) Inhibitors of amino acid and protein synthesis
      methionine synthesis inhibitors (anilino-pyrimidines): cyprodinil, mepanipyrim, pyrimethanil;
      protein synthesis inhibitors: blasticidin-S, kasugamycin, kasugamycin hydrochloride-hydrate, mildiomycin, streptomycin, oxytetracyclin, polyoxine, validamycin A;
   F) Signal transduction inhibitors
      MAP/histidine kinase inhibitors: fluoroimid, iprodione, procymidone, vinclozolin, fenpiclonil, fludioxonil;
      G protein inhibitors: quinoxyfen;
   G) Lipid and membrane synthesis inhibitors
      Phospholipid biosynthesis inhibitors: edifenphos, iprobenfos, pyrazophos, isoprothiolane;
      lipid peroxidation: dicloran, quintozene, tecnazene, tolclofos-methyl, biphenyl, chloroneb, etridiazole;
      phospholipid biosynthesis and cell wall deposition: dimethomorph, flumorph, mandipropamid, pyrimorph, benthiavalicarb, iprovalicarb, valifenalate and N-(1-(1-(4-cyano-phenyl)ethanesulfonyl)-but-2-yl) carbamic acid-(4-fluorophenyl) ester;
      compounds affecting cell membrane permeability and fatty acids: propamocarb, propamocarb-hydrochlorid
      fatty acid amide hydrolase inhibitors: oxathiapiprolin;
   H) Inhibitors with Multi Site Action
      inorganic active substances: Bordeaux mixture, copper acetate, copper hydroxide, copper oxychloride, basic copper sulfate, sulfur;
      thio- and dithiocarbamates: ferbam, mancozeb, maneb, metam, metiram, propineb, thiram, zineb, ziram;
      organochlorine compounds (e.g. phthalimides, sulfamides, chloronitriles): anilazine, chlorothalonil, captafol, captan, folpet, dichlofluanid, dichlorophen, hexachlorobenzene, pentachlorphenole and its salts, phthalide, tolylfluanid, N-(4-chloro-2-nitro-phenyl)-N-ethyl-4-methyl-benzenesulfonamide;
      guanidines and others: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithiino[2,3-c:5,6-c′]dipyrrole-1,3,5,7(2H,6H)-tetraone;
   I) Cell wall synthesis inhibitors
      inhibitors of glucan synthesis: validamycin, polyoxin B; melanin synthesis inhibitors: pyroquilon, tricyclazole, carpropamid, dicyclomet, fenoxanil;
   J) Plant defence inducers
      acibenzolar-S-methyl, probenazole, isotianil, tiadinil, prohexadione-calcium; phosphonates: fosetyl, fosetyl-aluminum, phosphorous acid and its salts;
   K) Unknown mode of action
      bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, picarbutrazox, tolprocarb, 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, methoxy-acetic acid 6-tert-butyl-8-fluoro-2,3-dimethyl-quinolin-4-yl ester, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl)cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide, ethyl (Z)-3-amino-2-cyano-3-phenyl-prop-2-enoate, pentyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(8-fluoro-2-methyl-3-quinolyl)oxy]phenyl]propan-2-ol, 3-(5-fluoro-3,3,4,4-tetramethyl-3,4-dihydroisoquinolin-1-yl)quinoline, 3-(4,4-difluoro-3,3-dimethyl-3,4-dihydroisoquinolin-1-yl)-quinoline, 3-(4,4,5-trifluoro-3,3-dimethyl-3,4-dihydroisoquinolin-1-yl)quinoline;
or
2) one insecticidal compound IB selected from the group consisting of:
   M.1 Acetylcholine esterase (AChE) inhibitors from the class of
   M.1A carbamates, for example aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of
   M.1B organophosphates, for example acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;
   M.2. GABA-gated chloride channel antagonists such as:
   M.2A cyclodiene organochlorine compounds, as for example endosulfan or chlordane; or
   M.2B fiproles (phenylpyrazoles), as for example ethiprole, fipronil, flufiprole, pyrafluprole and pyriprole;
   M.3 Sodium channel modulators from the class of
   M.3A pyrethroids, for example acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or
   M.3B sodium channel modulators such as DDT or methoxychlor;
   M.4 Nicotinic acetylcholine receptor agonists (nAChR) from the class of
   M.4A neonicotinoids, for example acteamiprid, chlothianidin, dinotefuran, imidacloprid, nitenpyram, thiacloprid and thiamethoxam; or the compounds
   M.4A.1: 1-[(6-chloro-3-pyridinyl)methyl]-2,3,5,6,7,8-hexahydro-9-nitro-(5S,8R)-5,8-Epoxy-1H-imidazo[1,2-a]azepine; or
   M.4A.2: 1-[(6-chloro-3-pyridyl)methyl]-2-nitro-1-[(E)-pentylideneamino]guanidine; or
   M4.A.3: 1-[(6-chloro-3-pyridyl)methyl]-7-methyl-8-nitro-5-propoxy-3,5,6,7-tetrahydro-2H-imidazo[1,2-a]pyridine;
   or M.4B nicotine.
   M.5 Nicotinic acetylcholine receptor allosteric activators from the class of spinosyns, for example spinosad or spinetoram;
   M.6 Chloride channel activators from the class of avermectins and milbemycins, for example abamectin, emamectin benzoate, ivermectin, lepimectin or milbemectin;
   M.7 Juvenile hormone mimics, such as
   M.7A juvenile hormone analogues as hydroprene, kinoprene and methoprene; or others as M.7B fenoxycarb or M.7C pyriproxyfen;
   M.8 miscellaneous non-specific (multi-site) inhibitors, for example
   M.8A alkyl halides as methyl bromide and other alkyl halides, or
   M.8B chloropicrin, or M.8C sulfuryl fluoride, or M.8D borax, or M.8E tartar emetic;
   M.9 Selective homopteran feeding blockers, for example
   M.9B pymetrozine, or M.9C flonicamid;
   M.10 Mite growth inhibitors, for example
   M.10A clofentezine, hexythiazox and diflovidazin, or M.10B etoxazole;
   M.11 Microbial disruptors of insect midgut membranes, for example bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;
   M.12 Inhibitors of mitochondrial ATP synthase, for example
   M.12A diafenthiuron, or
   M.12B organotin miticides such as azocyclotin, cyhexatin or fenbutatin oxide, or M.12C propargite, or M.12D tetradifon;
   M.13 Uncouplers of oxidative phosphorylation via disruption of the proton gradient, for example chlorfenapyr, DNOC or sulfluramid;
   M.14 Nicotinic acetylcholine receptor (nAChR) channel blockers, for example nereistoxin analogues as bensultap, cartap hydrochloride, thiocyclam or thiosultap sodium;
   M.15 Inhibitors of the chitin biosynthesis type 0, such as benzoylureas as for example bistrifluron, chlorfluazuron, diflubenzuron, flucycloxuron, flufenoxuron, hexaflumuron, lufenuron, novaluron, noviflumuron, teflubenzuron or triflumuron;
   M.16 Inhibitors of the chitin biosynthesis type 1, as for example buprofezin;
   M.17 Moulting disruptors, Dipteran, as for example cyromazine;
   M.18 Ecdyson receptor agonists such as diacylhydrazines, for example methoxyfenozide, tebufenozide, halofenozide, fufenozide or chromafenozide;
   M.19 Octopamin receptor agonists, as for example amitraz;
   M.20 Mitochondrial complex III electron transport inhibitors, for example
   M.20A hydramethylnon, or M.20B acequinocyl, or M.20C fluacrypyrim;
   M.21 Mitochondrial complex I electron transport inhibitors, for example
   M.21A METI acaricides and insecticides such as fenazaquin, fenpyroximate, pyrimidifen, pyridaben, tebufenpyrad or tolfenpyrad, or M.21B rotenone;
   M.22 Voltage-dependent sodium channel blockers, for example
   M.22A indoxacarb, or M.22B metaflumizone, or M.22C 1-[(E)-[2-(4-cyanophenyl)-1-[3-(trifluoromethyl)phenyl]ethylidene]amino]-3-[4-(difluoromethoxy)phenyl]urea;
   M.23 Inhibitors of the of acetyl CoA carboxylase, such as Tetronic and Tetramic acid derivatives, for example spirodiclofen, spiromesifen or spirotetramat;
   M.24 Mitochondrial complex IV electron transport inhibitors, for example
   M.24A phosphine such as aluminium phosphide, calcium phosphide, phosphine or zinc phosphide, or M.24B cyanide.
   M.25 Mitochondrial complex II electron transport inhibitors, such as beta-ketonitrile derivatives, for example cyenopyrafen or cyflumetofen;
   M.28 Ryanodine receptor-modulators from the class of diamides, as for example flubendiamide, chlorantraniliprole (Rynaxypyr®), cyantraniliprole (Cyazypyr®), or the phthalamide compounds
   M.28.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and
   M.28.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or the compound
   M.28.3: 3-bromo-N-{2-bromo-4-chloro-6-[(1-cyclopropylethyl)carbamoyl]phenyl}-1-(3-chlorpyridin-2-yl)-1H-pyrazole-5-carboxamide (proposed ISO name: cyclaniliprole), or the compound
   M.28.4: methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate; or a compound selected from M.28.5a) to M.28.5l):
   M.28.5a) N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide;
   M.28.5b) N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide;
   M.28.5c) N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide;
   M.28.5d) N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide;
   M.28.5e) N-[4,6-dichloro-2-[(diethyl-lambda-4-sulfanylidene)carbamoyl]-phenyl]-2-(3-chloro-2-pyridyl)-5-(difluoromethyl)pyrazole-3-carboxamide;
   M.28.5f) N-[4,6-dibromo-2-[(di-2-propyl-lambda-4-sulfanylidene)carbamoyl]-phenyl]-2-(3-chloro-2-pyridyl)-5-(trifluoromethyl)pyrazole-3-carboxamide;
   M.28.5g) N-[4-chloro-2-[(di-2-propyl-lambda-4-sulfanylidene)carbamoyl]-6-cyano-phenyl]-2-(3-chloro-2-pyridyl)-5-(trifluoromethyl)pyrazole-3-carboxamide;
   M.28.5h) N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide;
   M.28.5i) N-[2-(5-amino-1,3,4-thiadiazol-2-yl)-4-chloro-6-methyl-phenyl]-5-bromo-2-(3-chloro-2-pyridyl)pyrazole-3-carboxamide;
   M.28.5j) 5-chloro-2-(3-chloro-2-pyridyl)-N-[2,4-dichloro-6-[(1-cyano-1-methyl-ethyl)carbamoyl]phenyl]pyrazole-3-carboxamide;
   M.28.5k) 5-bromo-N-[2,4-dichloro-6-(methylcarbamoyl)phenyl]-2-(3,5-dichloro-2-pyridyl)pyrazole-3-carboxamide;
   M.28.5l) N-[2-(tert-butylcarbamoyl)-4-chloro-6-methyl-phenyl]-2-(3-chloro-2-pyridyl)-5-(fluoromethoxy)pyrazole-3-carboxamide; or a compound selected from
   M.28.6 N2-(1-cyano-1-methyl-ethyl)-N1-(2,4-dimethylphenyl)-3-iodo-phthalamide; or
   M.28.7 3-chloro-N2-(1-cyano-1-methyl-ethyl)-N1-(2,4-dimethylphenyl)phthalamide;
   M.UN.X insecticidal active compounds of unknown or uncertain mode of action, as for example afidopyropen, azadirachtin, amidoflumet, benzoximate, bifenazate, bromopropylate, chinomethionat, cryolite, dicofol, flufenerim, flometoquin, fluensulfone, flupyradifurone, piperonyl butoxide, pyridalyl, pyrifluquinazon, sulfoxaflor, pyflubumide or the compounds
   M.UN.X.1: 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound
   M.UN.X.2: 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or the compound
   M.UN.X.3: 11-(4-chloro-2,6-dimethylphenyl)-12-hydroxy-1,4-dioxa-9-azadispiro[4.2.4.2]-tetradec-11-en-10-one, or the compound
   M.UN.X.4: 3-(4′-fluoro-2,4-dimethylbiphenyl-3-yl)-4-hydroxy-8-oxa-1-azaspiro[4.5]dec-3-en-2-one, or the compound
   M.UN.X.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, I-1582); or
   M.UN.X.6; a compound selected from the group of
   M.UN.X.6a) (E/Z)—N-[1-[(6-chloro-3-pyridyl)methyl]-2-pyridylidene]-2,2,2-trifluoro-acetamide;
   M.UN.X.6b) (E/Z)—N-[1-[(6-chloro-5-fluoro-3-pyridyl)methyl]-2-pyridylidene]-2,2,2-trifluoro-acetamide;
   M.UN.X.6c) (E/Z)-2,2,2-trifluoro-N-[1-[(6-fluoro-3-pyridyl)methyl]-2-pyridylidene]acetamide;
   M.UN.X.6d) (E/Z)—N-[1-[(6-bromo-3-pyridyl)methyl]-2-pyridylidene]-2,2,2-trifluoro-acetamide;
   M.UN.X.6e) (E/Z)—N-[1-[1-(6-chloro-3-pyridyl)ethyl]-2-pyridylidene]-2,2,2-trifluoro-acetamide;
   M.UN.X.6f) (E/Z)—N-[1-[(6-chloro-3-pyridyl)methyl]-2-pyridylidene]-2,2-difluoro-acetamide;
   M.UN.X.6g) (E/Z)-2-chloro-N-[1-[(6-chloro-3-pyridyl)methyl]-2-pyridylidene]-2,2-difluoro-acetamide;
   M.UN.X.6h) (E/Z)—N-[1-[(2-chloropyrimidin-5-yl)methyl]-2-pyridylidene]-2,2,2-trifluoro-acetamide and
   M.UN.X.6i) (E/Z)—N-[1-[(6-chloro-3-pyridyl)methyl]-2-pyridylidene]-2,2,3,3,3-pentafluoro-propanamide.); or of the compounds
   M.UN.X.7: 3-[3-chloro-5-(trifluoromethyl)phenyl]-4-oxo-1-(pyrimidin-5-ylmethyl)pyrido[1,2-a]pyrimidin-1-ium-2-olate; or
   M.UN.X.8: 8-chloro-N-[2-chloro-5-methoxyphenyl)sulfonyl]-6-trifluoromethyl)-imidazo[1,2-a]pyridine-2-carboxamide; or
   M.UN.X.9: 4-[5-(3,5-dichlorophenyl)-5-(trifluoromethyl)-4H-isoxazol-3-yl]-2-methyl-N-(1-oxothietan-3-yl)benzamide; or
   M.UN.X.10: 5-[3-[2,6-dichloro-4-(3,3-dichloroallyloxyl)phenoxy]propoxy]-1H-pyrazole;
or
3) one antifungal biocontrol agent or plant bioactivator IC selected from the group consisting of:
   L1) Microbial pesticides with fungicidal, bactericidal, viricidal and/or plant defense activator activity: Ampelomyces quisqualis, Aspergillus flavus, Aureobasidium pullulans, Bacillus amyloliquefaciens, B. mojavensis, B. pumilus, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus polymyxa, Pantoea vagans, Phlebiopsis gigantea, Pseudomonas sp., Pseudomonas chloraphis, Pseudozyma flocculosa, Pichia anomala, Pythium oligandrum, Streptomyces griseoviridis, S. lydicus, S. violaceusniger, Talaromyces flavus, Trichoderma asperellum, T. atroviride, T. gamsii, T. harmatum; T. harzianum, mixture of T. harzia [symbol] num and T. viride; mixture of T. polysporum and T. harzianum; T. stromaticum, T. virens (also named Gliocladium virens), T. viride, Typhula phacorrhiza, Ulocladium oudemansii, Verticillium dahlia, zucchini yellow mosaic virus (avirulent strain);
   L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium or sodium bicarbonate, Reynoutria sachlinensis extract, salicylic acid, tea tree oil;
   L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia sp., Chromobacterium subtsugae, Cydia pomonella granulosis virus, Cryptophlebia leucotreta granulovirus (CrleGV), Isaria fumosorosea, Heterorhabditis bacteriophora, Lecanicillium longisporum, L. muscarium (formerly Verticillium lecanii), Metarhizium anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramose, P. reneformis, P. thornea, P. usgae, Pseudomonas fluorescens, Steinernema carpocapsae, S. feltiae, S. kraussei;
   L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Tagetes oil;
   L5) Microbial pesticides with plant stress reducing, plant growth regulator, plant growth promoting and/or yield enhancing activity: Azospirillum amazonense A. brasilense, A. lipoferum, A. irakense, A. halopraeferens, Delftia acidovorans, Glomus intraradices, Penicillium bilaiae;
   L6) Biochemical pesticides with plant stress reducing, plant growth regulator and/or plant yield enhancing activity: abscisic acid, aluminium silicate (kaolin), 3-decen-2-one, formononetin, genistein, hesperetin, homobrassinlide, humates, lysophosphatidyl ethanolamine, naringenin, polymeric polyhydroxy acid, Ascophyllum nodosum (Norwegian kelp, Brown kelp) extract and Ecklonia maxima (kelp) extract;
and
4) one compound II selected from jasmonic acid, salts or derivatives thereof.

The above-referred mixtures are herein below also referred as “inventive mixtures”.

One typical problem arising in the field of pest control lies in the need to reduce the dosage rates of the active ingredient in order to reduce or avoid unfavorable environmental or toxicological effects whilst still allowing effective pest control.

In regard to the instant invention the term pests embrace animal pests, and harmful fungi.

Another problem encountered concerns the need to have available pest control agents which are effective against a broad spectrum of pests, e.g. both animal pests and harmful fungi.

There also exists the need for pest control agents that combine knock-down activity with prolonged control, that is, fast action with long lasting action.

Another difficulty in relation to the use of pesticides is that the repeated and exclusive application of an individual pesticidal compound leads in many cases to a rapid selection of pests, that means animal pests, and harmful fungi, which have developed natural or adapted resistance against the active compound in question. Therefore there is a need for pest control agents that help prevent or overcome resistance.

Another problem underlying the present invention is the desire for compositions that improve plants, a process which is commonly and hereinafter referred to as “plant health”.

It was therefore an object of the present invention to provide pesticidal mixtures which solve the problems of reducing the dosage rate and/or enhancing the spectrum of activity and/or combining knock-down activity with prolonged control and/or to resistance management and/or promoting the health of plants.

A need was also the provision of pesticidal mixtures increasing the health of plants.

Selected combinations with jasmonates and plant growth regulators, selected pesticides and micronutrients are known in the art.

For example, WO12047608A2 explicitly refers to combinations of jasmonates and glyphosate, glufosinate, specific bacillus spp., mefenoxam (=metalaxyl-M), thiamethoxam, difenoconazole, metalaxyl-M, fludioxonil and bacillus subtilis.

However, this application does not describe all benefits of the mixtures according to the present invention.

WO 07/001919 generally relates to plant growth regulators and strobilurines, including foliar application.

However, fails to teach all aspects and elements of the present invention.

WO 2010/063446 describes composition of plant growth regulators and jasmonate.

U.S. Pat. No. 6,030,977A refers to pyrimethanil and inter alia jasmonic acid

U.S. Pat. No. 7,176,163 relates to the use of jasmonate (methyl-jasmonate) for enhancing the pharmacological action of a pesticide.

WO2011063946 relates to methods of regulating growth of and/or enhancing crop plants e.g. cereals, comprises applying plant growth regulator (e.g. paclobutrazol) and jasmonic acid to the plants, plant parts, plant propagation material or plant growing locus

Furthermore, jasmonates can be found as mixing partners amongst other pesticides in WO2011151248, WO2011080044], WO2010081645, WO2010081646 and WO2012061288 as mixing partner for selected pesticides, but also

the following combinations of jasmonates and further compounds are known:
1-MCP (Syngenta [WO2011153445]), Isatin [CN102267935], maleic hydrazide [KR2011035617], chitosan [KR1079039], ctinomycetes bacteria [WO2011025395], esterase inhibitors and/or oxidase inhibitors and various compounds, inter alia methyl jasmonate [WO2009060165], auxins [WO2005018319], Poly-phenol [WO2004066730], Spermine [JP2004149420/JP4188055], Mite repellent [EP1407666], abscisic acids [EP2003335607], Phosphite, a plant defense elicitor and a fungicide [WO2003092384], abscisic acid, 2,4-D-propionic acid, glyphosate, jasmonic acid, methyl jasmonate and/or ethrel, and adjuvant [WO2003090535], salicylic acid [CN102100231],
Dormin [WO2002087332], in combination with micronutrients and benzoic acid derivatives [such as plant growth regulatros (salicylic acid) or herbicide (Dicamba)] [US20090038355], gibberilines [WO1997031536], a plant nutrient, and microorganisms and inducer (e.g. jasmonic acid) [US20040242424, US20040242419, US20040242418], herbicidees and metal chelate and inducer (e.g. jasmonates) [WO2003073856] and Jasmonic acid as plant growth regulatros in combination with selected adjuvants [WO2003020028].

However, none of the above-referred applications teaches the mixtures and/or the selected benefits of all mixtures according to the present invention.

We have found that this object is in part or in whole achieved by the mixtures comprising the active compounds defined in the outset.

It has been found that the action of the inventive mixtures goes far beyond the fungicidal and/or insecticidal and/or plant health improving action of the active compounds I present in the mixture alone.

Thus, the invention relates to a method for controlling pests, this refers to includes animal pests and harmful fungi, using the inventive mixtures and to the use of compound I and compound II for preparing such mixtures, and also to compositions comprising such mixtures.

In particular, the present invention relates to method for controlling pests, wherein the pest, their habitat, breeding grounds, their locus or the plants to be protected against pest attack, the soil or plant propagation material are treated with a pesticidally effective amount of the inventive mixture.

In particular, the present invention relates to method for controlling harmful fungi, wherein the harmful fungi, their habitat, breeding grounds, their locus or the plants to be protected against fungal attack, the soil or plant propagation material are treated with a pesticidally effective amount of the inventive mixture.

In particular, the present invention relates to method for controlling harmful insects (protecting plants from attack or infestation by animal pests (insects, acarids or nematodes), wherein the harmful insects, their habitat, breeding grounds, their locus or the plants to be protected against insecticidal attack, the soil or plant propagation material are treated with an pesticidally effective amount of the inventive mixture.

Additionally, the present invention also comprises a method for protection of plant propagation material (preferably seed) from harmful pests, such as fungi or insects, arachnids or nematodes comprising contacting the plant propagation materials (preferably seeds) with an inventive mixture comprising compound I and II in pesticidally effective amounts.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring. In a particular preferred embodiment, the term propagation material denotes seeds.

Additionally, the present invention also comprises a method for protection of plant propagation material (preferably seed) from harmful fungi comprising contacting the plant propagation materials (preferably seeds) with the inventive mixtures comprising compound IA or IC and II in pesticidally effective amounts.

Additionally, the present invention also comprises a method for protection of plant propagation material (preferably seed) from harmful insects comprising contacting the plant propagation materials (preferably seeds) with the inventive mixtures comprising compound IB or IC and II in pesticidally effective amounts.

The methods for protection of plant propagation material (preferably seed) from harmful pests are particularly preferred.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

The present invention further relates to plant-protecting active ingredient mixtures having synergistically enhanced action of improving the health of plants and to a method of applying such inventive mixtures to the plants.

Thus, we have found that simultaneous, that is joint or separate, application of the compound I and the compound II or successive application of the compound I and the compound II provides enhanced plant health effects compared to the plant health effects that are possible with the individual compounds (synergistic mixtures).

Thus, the present invention also comprises a method for increasing the heath of plants comprising protection of plant propagation material (preferably seed) from harmful fungi comprising contacting the plant propagation materials (preferably seeds) with the inventive mixtures comprising compound IA or IC and II in pesticidally effective amounts or plant health effective amount.

Moreover, we have found that simultaneous, that is joint or separate, application of the compound I and the compound II or successive application of the compound I and the compound II allows enhanced control of pests, that means harmful fungi or animal pests, compared to the control rates that are possible with the individual compounds (synergistic mixtures).

Thus, the present invention further relates to plant-protecting active ingredient mixtures having synergistically enhanced action of controlling harmful fungi and animal pests (insects, arachnids and nematodes) and to a method of applying such inventive mixture to the plants.

In particular, the present invention further relates to plant-protecting active ingredient mixtures having synergistically enhanced action of controlling animal pests (insects, arachnids and nematodes) and to a method of applying such inventive mixtures to the plants.

Thus, the invention relates to a method for controlling pests, this refers to includes animal pests and harmful fungi, using the inventive mixture having synergistically enhanced action for controlling animal pests and harmful fungi and to the use of compound I and compound II for preparing such mixtures, and also to compositions comprising such mixtures.

In particular, the present invention relates to a method for controlling pests and/or improving the health of plants, wherein the pest, their habitat, breeding grounds, their locus or the plants to be protected against pest attack are treated with an effective amount of an inventive mixture.

In a preferred embodiment, the present invention relates to a method for controlling pests, wherein the pest, their habitat, breeding grounds, their locus or the plants to be protected against pest attack are treated with an effective amount of an inventive mixture.

In an equally preferred embodiment, the present invention relates to a method for controlling harmful fungi, wherein the fungi, their habitat, breeding grounds, their locus or the plants to be protected against fungal attack are treated with an effective amount of an inventive mixture comprising (compound IA or compound IC) and compound II.

In an equally preferred embodiment, the present invention relates to a method for controlling animal pests (insects, acarids or nematodes), wherein the animal pests (insects, acarids or nematodes), their habitat, breeding grounds, their locus or the plants to be protected against animal pest (insects, acarids or nematodes) attack are treated with an effective amount of an inventive mixture comprising compound IB and compound II.

In an equally preferred embodiment, the present invention relates to a method for improving the health of plants, wherein the plants are treated with an effective amount of an inventive mixture.

In particular, the present invention relates to a method for protection of plant propagation material from pests and/or improving the health of plants, wherein the plant propagation material or the soil is treated with an effective amount of an inventive mixture.

In particular, the present invention relates to a method for protection of plant propagation material from pests, wherein the plant propagation material is treated with an effective amount of an inventive mixture.

In a preferred embodiment, the present invention relates to a method for protection of plant propagation material from animal pests (insects, acarids or nematodes), wherein the plant propagation material are treated with an effective amount of an inventive mixture comprising compound IB and compound II.

In an equally preferred embodiment, the present invention relates to a method for protection of plant propagation material from harmful fungi, wherein the plant propagation material is treated with an effective amount of an inventive mixture comprising (compound IA or IC) and compound II.

In an equally preferred embodiment, the present invention relates to a method for improving the health of plants grown from said plant propagation material, wherein the plant propagation material is treated with an effective amount of an inventive mixture.

The term “plant health effective amount” denotes an amount of the inventive mixtures, which is sufficient for achieving plant health effects as defined herein below. More exemplary information about amounts, ways of application and suitable ratios to be used is given below. Anyway, the skilled artisan is well aware of the fact that such an amount can vary in a broad range and is dependent on various factors, e.g. the treated cultivated plant or material and the climatic conditions.

In the inventive mixtures, the ratio by weight of compound I and II is from 500:1 to 1:500, preferably from 100:1 to 1:100 more preferably from 50:1 to 1:50, most preferably from 20:1 to 1:20. Utmost preferred ratios are from 10:1 to 1:10.

The remaining compounds IA, IB, IC and II as well as their pesticidal action and methods for producing them are generally known. For instance, they may be found in the e-Pesticide Manual V5.2 (ISBN 978 1 901396 85 0) (2008-2011) among other publications or in the references given above.

Salts of jasmonic acid or derivatives include without limitation the jasmonate salts potassium jasmonate, sodium jasmonate, lithium jasmonate, ammonium jasmonate, dimethylammonium jasmonate, isopropylammonium jasmonate, diolammonium jasmonate, diethtriethanolammonium jasmonate, jasmonic acid methyl ester, jasmonic acid amide, jasmonic acid methylamide, jasmonic acid-L-amino acid (amide-linked) conjugates (e.g., conjugates with L-isoleucine, L-valine, L-leucine, or L-phenylalanine), 12-oxo-phytodienoic acid, coronatine, coronafacoyl-L-serine, coronafacoyl-L-threonine, methyl esters of 1-oxo-indanoyl-isoleucine, methyl esters of 1-oxo-indanoyl-leucine, coronalon (2-[(6-ethyl-1-oxo-indane-4-carbonyl)-amino]-3-methyl-pentanoic acid methyl ester), linoleic acid or derivatives thereof, or combinations of any of the above.

Healthier plants are desirable since they result among others in better yields and/or a better quality of the plants or crops. Healthier plants also better resist to biotic and/or abiotic stress. A high resistance against biotic stresses in turn allows the person skilled in the art to reduce the quantity of pesticides applied and consequently to slow down the development of resistances against the respective pesticides.

It was therefore an object of the present invention to provide a pesticidal composition which solves the problems outlined above, and which should, in particular, improve the health of plants, in particular the yield of plants.

The term “health of a plant” or “plant health” is defined as a condition of the plant and/or its products which is determined by several aspects alone or in combination with each other such as increased yield, plant vigor, quality and tolerance to abiotic and/or biotic stress.

It has to be emphasized that the above mentioned effects of the inventive mixtures, i.e. enhanced health of the plant, are also present when the plant is not under biotic stress and in particular when the plant is not under pest pressure. It is evident that a plant suffering from fungal or insecticidal attack produces a smaller biomass and leads to a reduced yield as compared to a plant which has been subjected to curative or preventive treatment against the pathogenic fungus or any other relevant pest and which can grow without the damage caused by the biotic stress factor. However, the methods according to the invention lead to an enhanced plant health even in the absence of any biotic stress. This means that the positive effects of the mixtures of the invention cannot be explained just by the fungicidal and/or insecticidal activities of the compounds (I) and (II), but are based on further activity profiles. Accordingly, the application of the inventive mixtures can also be carried out in the absence of pest pressure.

Each listed plant health indicator listed below, and which is selected from the groups consisting of yield, plant vigor, quality and tolerance to abiotic and/or biotic stress, is to be understood as a preferred embodiment of the present invention either each on its own or preferably in combination with each other.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the inventive mixture.

Increased yield can be characterized, among others, by the following improved properties of the plant: increased plant weight; and/or increased plant height; and/or increased biomass such as higher overall fresh weight (FW); and/or increased number of flowers per plant; and/or higher grain and/or fruit yield; and/or more tillers or side shoots (branches); and/or larger leaves; and/or increased shoot growth; and/or increased protein content; and/or increased oil content; and/or increased starch content; and/or increased pigment content; and/or increased chlorophyll content (chlorophyll content has a positive correlation with the plant's photosynthesis rate and accordingly, the higher the chlorophyll content the higher the yield of a plant)

“Grain” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant.

According to the present invention, the yield is increased by at least 4%, preferable by 5 to 10%, more preferable by 10 to 20%, or even 20 to 30%. In general, the yield increase may even be higher.

Another indicator for the condition of the plant is the plant vigor. The plant vigor becomes manifest in several aspects such as the general visual appearance.

Improved plant vigor can be characterized, among others, by the following improved properties of the plant: improved vitality of the plant; and/or improved plant growth; and/or improved plant development; and/or improved visual appearance; and/or improved plant stand (less plant verse/lodging); and/or improved emergence; and/or enhanced root growth and/or more developed root system; and/or enhanced nodulation, in particular rhizobial nodulation; and/or bigger leaf blade; and/or bigger size; and/or increased plant height; and/or increased tiller number; and/or increased number of side shoots; and/or increased number of flowers per plant; and/or increased shoot growth; and/or enhanced photosynthetic activity (e.g. based on increased stomatal conductance and/or increased CO₂ assimilation rate); and/or enhanced pigment content; and/or earlier flowering; and/or earlier fruiting; and/or earlier and improved germination; and/or earlier grain maturity; and/or less non-productive tillers; and/or less dead basal leaves; and/or less input needed (such as fertilizers or water); and/or greener leaves; and/or complete maturation under shortened vegetation periods; and/or less seeds needed; and/or easier harvesting; and/or faster and more uniform ripening; and/or longer shelf-life; and/or longer panicles; and/or delay of senescence; and/or stronger and/or more productive tillers; and/or better extractability of ingredients; and/or improved quality of seeds (for being seeded in the following seasons for seed production); and/or reduced production of ethylene and/or the inhibition of its reception by the plant.

Another indicator for the condition of the plant is the “quality” of a plant and/or its products. According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product: increased nutrient content; and/or increased protein content; and/or increased content of fatty acids; and/or increased metabolite content; and/or increased carotenoid content; and/or increased sugar content; and/or increased amount of essential amino acids; and/or improved nutrient composition; and/or improved protein composition; and/or improved composition of fatty acids; and/or improved metabolite composition; and/or improved carotenoid composition; and/or improved sugar composition; and/or improved amino acids composition; and/or improved or optimal fruit color; and/or improved leaf color; and/or higher storage capacity; and/or higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with an inventive mixture and (2.) that the negative effects are not diminished by a direct action of the inventive mixture on the stress factors, e.g. by its fungicidal or insecticidal action which directly destroys the microorganisms or pests, but rather by a stimulation of the plants' own defensive reactions against said stress factors.

Negative factors caused by biotic stress such as pathogens and pests are widely known and range from dotted leaves to total destruction of the plant. Biotic stress can be caused by living organisms, such as competing plants (for example weeds), microorganisms (such as phytho-pathogenic fungi and/or bacteria) and/or viruses.

Negative factors caused by abiotic stress are also well-known and can often be observed as reduced plant vigor (see above), for example: dotted leaves, “burned leaves”, reduced growth, less flowers, less biomass, less crop yields, reduced nutritional value of the crops, later crop maturity, to give just a few examples. Abiotic stress can be caused for example by: extremes in temperature such as heat or cold (heat stress/cold stress); and/or strong variations in temperature; and/or temperatures unusual for the specific season; and/or drought (drought stress); and/or extreme wetness; and/or high salinity (salt stress); and/or radiation (for example by increased UV radiation due to the decreasing ozone layer); and/or increased ozone levels (ozone stress); and/or organic pollution (for example by phythotoxic amounts of pesticides); and/or inorganic pollution (for example by heavy metal contaminants).

As a result of biotic and/or abiotic stress factors, the quantity and the quality of the stressed plants, their crops and fruits decrease. As far as quality is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

Advantageous properties, obtained especially from treated seeds, are e.g. improved germination and field establishment, better vigor and/or a more homogen field establishment.

As pointed out above, the above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

The antifungal biocontrol agents or plant bioactivators IC from group L1) and/or L2) may also have insecticidal, acaricidal, molluscidal, pheromone, nematicidal, plant stress reducing, plant growth regulator, plant growth promoting and/or yield enhancing activity. The antifungal biocontrol agents or plant bioactivators IC from group from group L3) and/or L4) may also have fungicidal, bactericidal, viricidal, plant defense activator, plant stress reducing, plant growth regulator, plant growth promoting and/or yield enhancing activity. The antifungal biocontrol agents or plant bioactivators from group L5) and/or L6) may also have fungicidal, bactericidal, viricidal, plant defense activator, insecticidal, acaricidal, molluscidal, pheromone and/or nematicidal activity.

Strains can be sourced from genetic resource and deposition centers: American Type Culture Collection, 10801 University Blvd., Manassas, Va. 20110-2209, USA (strains with ATCC prefix); CABI Europe—International Mycological Institute, Bakeham Lane, Egham, Surrey, TW20 9TYNRRL, UK (strains with prefices CABI and IMI); Centraalbureau voor Schimmelcultures, Fungal Biodiversity Centre, Uppsalaan 8, PO Box 85167, 3508 AD Utrecht, Netherlands (strains with prefic CBS); Division of Plant Industry, CSIRO, Canberra, Australia (strains with prefix CC); Collection Nationale de Cultures de Microorganismes, Institut Pasteur, 25 rue du Docteur Roux, F-75724 PARIS Cedex 15 (strains with prefix CNCM); Leibniz-Institut DSMZ-Deutsche Sammlung von Mikroorganismen and Zellkulturen GmbH, Inhoffenstraβe 7 B, 38124 Braunschweig, Germany (strains with prefix DSM); International Depositary Authority of Canada Collection, Canada (strains with prefix IDAC); International Collection of Micro-organisms from Plants, Landcare Research, Private Bag 92170, Auckland Mail Centre, Auckland 1142, New Zealand (strains with prefix ICMP); IITA, PMB 5320, Ibadan, Nigeria (strains with prefix IITA); The National Collections of Industrial and Marine Bacteria Ltd., Torry Research Station, P.O. Box 31, 135 Abbey Road, Aberdeen, AB9 8DG, Scotland (strains with prefix NCIMB); ARS Culture Collection of the National Center for Agricultural Utilization Research, Agricultural Research Service, U.S. Department of Agriculture, 1815 North University Street, Peoria, Ill. 61604, USA (strains with prefix NRRL); Department of Scientific and Industrial Research Culture Collection, Applied Biochemistry Division, Palmerston North, New Zealand (strains with prefix NZP); FEPAGRO-Fundação Estadual de Pesquisa Agropecuária, Rua Gonçalves Dias, 570, Bairro Menino Deus, Porto Alegre/RS, Brazil (strains with prefix SEMIA); SARDI, Adelaide, South Australia (strains with prefix SRDI); U.S. Department of Agriculture, Agricultural Research Service, Soybean and Alfalfa Research Laboratory, BARC-West, 10300 Baltimore Boulevard, Building 011, Room 19-9, Beltsville, Md. 20705, USA (strains with prefix USDA: Beltsville Rhizobium Culture Collection Catalog March 1987 USDA-ARS ARS-30: http://pdf.usaid.gov/pdf_docs/PNAAW891.pdf); and Murdoch University, Perth, Western Australia (strains with prefix WSM). Further strains may be found at the Global catalogue of Microorganisms: http://gcm.wfcc.info/ and http://www.landcareresearch.co.nz/resources/collections/icmp and further references to strain collections and their prefixes at http://refs.wdcm.org/collections.htm.

In one embodiment the inventive mixtures effectuate an increased yield of a plant or its product.

In another embodiment the inventive mixtures effectuate an increased vigor of a plant or its product.

In another embodiment the inventive mixtures effectuate in an increased quality of a plant or its product.

In yet another embodiment the inventive mixtures effectuate an increased tolerance and/or resistance of a plant or its product against biotic stress.

In yet another embodiment the inventive mixtures effectuate an increased tolerance and/or resistance of a plant or its product against abiotic stress.

In a preferred embodiment of the invention, the inventive mixtures effect an increase in the yield.

In a preferred embodiment of the invention, the inventive mixtures the inventive mixtures effects an increase in the yield such as the plant weight and/or the plant biomass (e.g. overall fresh weight) and/or the grain yield and/or the number of tillers.

In another preferred embodiment of the invention, the inventive mixtures effect an improvement of the plant vigor.

In another preferred embodiment of the invention, the plant health effects of the inventive mixtures effect increased resistance of plant against biotic stress.

In another preferred embodiment of the invention, the plant health effects of the inventive mixtures effect increased resistance of plant against abiotic stress.

In a more preferred embodiment of the invention, the inventive mixtures effect an increase in the yield.

In a more preferred embodiment of the invention, the plant health effects of the inventive mixtures effect increased resistance of plant against biotic stress.

Preferred amongst the group of salts of jasmonic acid or derivatives are jasmonic acid, methyl jasmonate, sodium jasmonate, potassium jasmonate, lithium jasmonate and ammonium jasmonate. More preferred is jasmonic acid methyl ester.

Preferred mixtures are those comprising compound II and fungicidal compound IA selected from the group consisting of

A) Respiration inhibitors
Inhibitors of complex III at Qo site: azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, fenamidone;
inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate; (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate;
inhibitors of complex II (e. g. carboxamides): bixafen, boscalid, carboxin, fluopyram, fluxapyroxad, isopyrazam, penflufen, penthiopyrad, sedaxane, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide;
other respiration inhibitors: fluazinam; ametoctradin; and silthiofam;
   B) Sterol biosynthesis inhibitors (SBI fungicides)
C14 demethylase inhibitors (DMI fungicides): bitertanol, cyproconazole, difenoconazole, diniconazole, diniconazole-M, epoxiconazole, fluquinconazole, flusilazole, flutriafol, hexaconazole, ipconazole, metconazole, myclobutanil, propiconazole, prothioconazole, simeconazole, tebuconazole, tetraconazole, triadimenol, triticonazole, imazalil, pefurazoate, prochloraz, triflumizol;
Delta14-reductase inhibitors: fenpropimorph, spiroxamine;
   C) Nucleic acid synthesis inhibitors
phenylamides or acyl amino acid fungicides: benalaxyl, benalaxyl-M, kiralaxyl, metalaxyl, metalaxyl-M (mefenoxam), oxadixyl;
others: hymexazole, oxolinic acid;
   D) Inhibitors of cell division and cytoskeleton
tubulin inhibitors, such as benzimidazoles, thiophanates: benomyl, carbendazim, fuberidazole, thiabendazole, thiophanate-methyl;
other cell division inhibitors: ethaboxam, pencycuron, metrafenone;
   E) Inhibitors of amino acid and protein synthesis
methionine synthesis inhibitors (anilino-pyrimidines): cyprodinil, pyrimethanil;
   F) Signal transduction inhibitors
MAP/histidine kinase inhibitors: iprodione, fludioxonil;
   G) Lipid and membrane synthesis inhibitors
Phospholipid biosynthesis inhibitors: iprobenfos;
lipid peroxidation: quintozene, tolclofos-methyl, etridiazole;
phospholipid biosynthesis and cell wall deposition: dimethomorph, mandipropamid;
compounds affecting cell membrane permeability and fatty acids: propamocarb, propamocarb-hydrochlorid
   H) Inhibitors with Multi Site Action
inorganic active substances: Bordeaux mixture, copper acetate, copper hydroxide, copper oxychloride, basic copper sulfate, sulfur;
thio- and dithiocarbamates: ferbam, mancozeb, maneb, metiram, thiram;
organochlorine compounds (e.g. phthalimides, sulfamides, chloronitriles): chlorothalonil, captan, folpet;
guanidines and others: guanidine, dodine, guazatine, guazatine-acetate, iminoctadine, iminoctadine-triacetate, iminoctadine-tris(albesilate), dithianon;
   I) Cell wall synthesis inhibitors: validamycin, pyroquilon, tricyclazole;
   J) Plant defence inducers
acibenzolar-S-methyl, probenazole, isotianil, tiadinil, prohexadione-calcium, fosetyl, fosetyl-aluminum; and cymoxanil, oxine-copper, tecloftalam, triazoxide.

Especially preferred mixtures are those comprising compound II and fungicidal compound IA selected from the group consisting of: azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, and fenamidone.

Particularly preferred mixtures are those comprising compound II and pyraclostrobin, for example a mixture comprising jasmonic acid and pyraclostrobin, or a mixture comprising jasmonic acid methyl ester and pyraclostrobin.

Equally preferred mixtures are those comprising compound II and insecticidal compound IB selected from the group consisting of

M-1.A acetylcholine esterase inhibitors from the class of carbamates,
for example aldicarb, benfuracarb, carbofuran, carbosulfan, isoprocarb, methiocarb, methomyl, oxamyl, thiodicarb, and triazamate;
M-1.B organophosphates,
for example acephate, cadusafos, chlorethoxyfos, chlorfenvinphos, chlorpyrifos, chlorpyrifos-methyl, diazinon, dichlorvos/DDVP, dimethoate, disulfoton, ethoprophos, fenamiphos, fenitrothion, imicyafos, isofenphos, methamidophos, phoxim, profenofos, tebupirimfos, terbufos; M-2 GABA-gated chloride channel antagonists:
M-2.B fiproles (phenylpyrazoles),
for example ethiprole, fipronil, flufiprole, pyrafluprole, or pyriprole;
M-2. Others, for example 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide (known from WO 2007/079162) or the compound 4-[5-(3,5-dichlorophenyl)-5-(trifluoromethyl)-4H-isoxazol-3-yl]-2-methyl-N-[2-oxo-2-(2,2,2-trifluoroethylamino)ethyl]benzamide (known from WO 05/085216;
M-3 sodium channel modulators from the class of pyrethroids,
for example bifenthrin, cyfluthrin, beta-cyfluthrin, lambda-cyhalothrin, cypermethrin, alpha-cypermethrin, zeta-cypermethrin, deltamethrin, esfenvalerate, etofenprox, fenvalerate, flucythrinate, permethrin, tefluthrin;
M-4 nicotinic acetylcholine receptor agonists from the class of neonicotinoids;
for example acteamiprid, chlothianidin, cycloxaprid, dinotefuran, flupyradifurone, imidacloprid, nitenpyram, sulfoxaflor, thiacloprid, thiamethoxam or the compound 1-[(6-chloro-3-pyridyl)methyl]-7-methyl-8-nitro-5-propoxy-3,5,6,7-tetrahydro-2H-imidazo[1,2-a]pyridine (known from WO 2007/101369);
M-5 allosteric nicotinic acetylcholine receptor activators from the class of spinosyns,
for example spinosad, spinetoram;
M-6 chloride channel activators from the class of avermectins and milbemycins,
for example abamectin, emamectin benzoate, ivermectin, lepimectin or milbemectin;
M-9 selective homopteran feeding blockers,
for example pymetrozine or pyrifluquinazon;
M-11 microbial disruptors of insect midgut membranes,
for example bacillus thuringiensis, bacillus thuringiensis subsp. israelensis, bacillus sphaericus, bacillus thuringiensis subsp. aizawai, bacillus thuringiensis subsp. kurstaki, bacillus thuringiensis subsp. tenebrionis, or Bt crop proteins: Cry1Ab, Cry1Ac, Cry1Fa, Cry2Ab, mCry3A, Cry3Ab,

### Cry3Bb, or Cry34/35Ab1;

M-13 uncouplers of oxidative phosphorylation,
for example chlorfenapyr;
M-14 nicotinic acetylcholine receptor channel blockers,
for example cartap hydrochloride;
M-15 inhibitors of the chitin biosynthesis type 0 (benzoylurea class),
for example diflubenzuron, flufenoxuron, lufenuron, novaluron, teflubenzuron;
M-16 inhibitors of the chitin biosynthesis type 1,
for example buprofezin;
M-18 Ecdyson receptor agonists,
for example methoxyfenozide;
M-21 Mitochondrial complex I electron transport inhibitors,
for example: tebufenpyrad;
M-22 Voltage-dependent sodium channel blockers,
for example indoxacarb or metaflumizone;
M-23 Inhibitors of the lipid synthesis, inhibitors of acetyl CoA carboxylase,
for example spirodiclofen, or spirotetramat;
M-28 Ryanodine receptor-modulators from the class of diamides,
for example flubendiamide, chloranthraniliprole (rynaxypyr), cyanthraniliprole (cyazypyr), the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid or (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (both known from WO 2007/101540), the compound 3-bromo-N-{2-bromo-4-chloro-6-[(1-cyclopropylethyl)carbamoyl]phenyl}-1-(3-chlorpyridin-2-yl)-1H-pyrazole-5-carboxamide (known from WO 2005/077934), the compound methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate (known from WO 2007/043677), N2-[2-(3-chloro-2-pyridyl)-5-[(5-methyltetrazol-2-yl)methyl]pyrazol-3-yl]-5-cyano-N1,3-dimethyl-phthalamide (known from WO 2007/144100); and
2-(5-ethylsulfinyl-2-fluoro-4-methyl-phenyl)-5-methyl-1,2,4-triazol-3-amine (known from WO 06/043635), 1-(5-ethylsulfinyl-2,4-dimethyl-phenyl)-3-methyl-1,2,4-triazole (known from WO 06/043635.), bacillus firmus strain “CNCM I-1582” (known from WO 96/32840).

Equally preferred mixtures are those comprising compound II and antifungal biocontrol agent or plant bioactivator IC selected from the group consisting of
L1) Microbial pesticides with fungicidal, bactericidal, viricidal and/or plant defense activator activity: Ampelomyces quisqualis M-10, Aspergillus flavus NRRL 21882, Aureobasidium pullulans DSM 14940, A. pullulans DSM 14941, Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens FZB42, B. amyloliquefaciens IN937a, B. amyloliquefaciens IT-45 (CNCM I-3800), B. mojavensis AP-209 (NRRL B-50616), B. pumilus QST 2808 (NRRL B-30087), B. pumilus GHA 181, B. solisalsi AP-217 (NRRL B-50617), B. subtilis CX-9060, B. subtilis GB03, B. subtilis GB07, B. subtilis QST-713 (NRRL B-21661), B. subtilis var. amyloliquefaciens FZB24, B. subtilis var. amyloliquefaciens D747, Candida oleophila I-82, C. oleophila O, C. saitoana, Clavibacter michiganensis (bacteriophages), Coniothyrium minitans CON/M/91-08, Cryphonectria parasitica, Cryptococcus albidus, Dilophosphora alopecuri, Fusarium oxysporum, Clonostachys rosea f. catenulata J1446 (also named Gliocladium catenulatum), Gliocladium roseum 321U, Metschnikowia fructicola NRRL Y-30752, Microdochium dimerum, Microsphaeropsis ochracea P130A, Muscodor albus QST 20799, Paenibacillus polymyxa PKB1 (ATCC 202127), Pantoea vagans C9-1, Phlebiopsis gigantea, Pichia anomala WRL-76, Pseudozyma flocculosa PF-A22 UL, Pythium oligandrum DV 74, Streptomyces griseoviridis K61, S. lydicus WYEC 108, S. violaceusniger XL-2, S. violaceusniger YCED-9, Talaromyces flavus V117b, Trichoderma asperellum T34, T. asperellum SKT-1, T. asperellum ICC 012, T. atroviride LC52, T. atroviride CNCM I-1237, T. gamsii ICC 080, T. harmatum TH 382, T. harzianum TH-35, T. harzianum T-22, T. harzianum T-39; mixture of T. harzianum ICC012 and T. viride ICC080; mixture of T. polysporum and T. harzianum; T. stromaticum, T. virens (also named Gliocladium virens) GL-21, T. virens G41, T. viride TV1, Typhula phacorrhiza 94671, Ulocladium oudemansii HRU3, Verticillium dahlia, zucchini yellow mosaic virus (avirulent strain);
L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium bicarbonate, Reynoutria sachlinensis extract, salicylic acid, sodium bicarbonate, tea tree oil;
L3) Microbial pesticides with insecticidal, acaricidal, molluscidal and/or nematicidal activity:

Agrobacterium radiobacter K1026, A radiobacter K84, Bacillus firmus I-1582, B. thuringiensis ssp. aizawai strains ABTS-1857, SAN 401 I, ABG-6305 and ABG-6346, B. t. ssp. israelensis AM65-52, B. t. ssp. israelensis SUM-6218, B. t. ssp. galleriae SDS-502, B. t. ssp. kurstaki EG 2348, B. t. ssp. kurstaki SB4, B. t. ssp. kurstaki ABTS-351 (HD-1), Beauveria bassiana ATCC 74040, B. bassiana GHA, B. bassiana H123, B. bassiana DSM 12256, B. bassiana PPRI 5339, B. brongniartii, Burkholderia sp. A396, Chromobacterium subtsugae PRAA4-1, Cydia pomonella granulosis virus V22, Cydia pomonella granulosis virus V1, Isaria fumosorosea Apopka-97, Lecanicillium longisporum KV42, L. longisporum KV71, L. muscarium (formerly Verticillium lecanii) KV01, Metarhizium anisopliae FI-985, M. anisopliae FI-1045, M. anisopliae F52, M. anisopliae ICIPE 69, M. anisopliae var. acridum IMI 330189, Nomuraea rileyi strains SA86101, GU87401, SR86151, CG128 and VA9101, Paecilomyces fumosoroseus FE 9901, P. lilacinus 251, P. lilacinus DSM 15169, P. lilacinus BCP2, Paenibacillus popilliae Dutky-1940 (NRRL B-2309=ATCC 14706), P. popilliae KLN 3, P. popilliae Dutky 1, Pasteuria spp. Ph3, Pasteuria spp. ATCC PTA-9643, Pasteuria spp. ATCC SD-5832, P. nishizawae PN-1, P. penetrans, P. ramose, P. reneformis Pr-3, P. thornea, P. usgae, Pseudomonas fluorescens CL 145A, Steinernema carpocapsae, S. feltiae, S. kraussei L137;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Tagetes oil;
L5) Microbial pesticides with plant stress reducing, plant growth regulator, plant growth promoting and/or yield enhancing activity: Azospirillum amazonense BR 11140 (SpY2T), A. brasilense AZ39, A. brasilense XOH, A. brasilense BR 11005 (Sp245), A. brasilense BR 11002, A. lipoferum BR 11646 (Sp31), A. irakense, A. halopraeferens, Glomus intraradices RTI-801, Penicillium bilaiae;
L6) Biochemical pesticides with plant stress reducing, plant growth regulator and/or plant yield enhancing activity: abscisic acid, aluminium silicate (kaolin), 3-decen-2-one, formononectin, genistein, hesperetin, homobrassinlide, humates, lysophosphatidyl ethanlamine, naringenin, polymeric polyhydroxy acid, salicylic acid, Ascophyllum nodosum (Norwegian kelp, Brown kelp) extract and Ecklonia maxima (kelp) extract.

Preference is also given to mixtures comprising as antifungal biocontrol agent or plant bioactivator IC (the as antifungal biocontrol agent or plant bioactivator IC is hereinafter referred to as agent IC) a biopesticide from group L1), preferably selected from Bacillus amyloliquefaciens AP-136 (NRRL B-50614 and B-50330), B. amyloliquefaciens AP-188 (NRRL B-50615 and B-50331), B. amyloliquefaciens AP-218 (NRRL B-50618), B. amyloliquefaciens AP-219 (NRRL B-50619 and B-50332), B. amyloliquefaciens AP-295 (NRRL B-50620 and B-50333), B. amyloliquefaciens IT-45 (CNCM I-3800), B. mojavensis AP-209 (NRRL B-50616), B. pumilus QST 2808 (NRRL B-30087), B. pumilus GHA 181, B. solisalsi AP-217 (NRRL B-50617), B. subtilis CX-9060, B. subtilis GB03, B. subtilis GB07, B. subtilis QST-713 (NRRL B-21661), B. subtilis var. amyloliquefaciens FZB24, B. subtilis var. amyloliquefaciens D747, Paenibacillus polymyxa PKB1 (ATCC 202127), even more preferably from Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens IT-45 (CNCM I-3800), B. mojavensis AP-209 (NRRL B-50616), B. pumilus QST 2808 (NRRL B-30087), B. subtilis QST-713 (NRRL B-21661).

These mixtures are particularly suitable in soybean and corn.

According to one embodiment of the inventive mixtures, the at least one agent IC is selected from Bacillus amyloliquefaciens AP-136, B. amyloliquefaciens AP-188, B. amyloliquefaciens AP-218, B. amyloliquefaciens AP-219, B. amyloliquefaciens AP-295, B. amyloliquefaciens FZB42, B. amyloliquefaciens IN937a, B. amyloliquefaciens IT-45, B. mojavensis AP-209, B. pumilus GB34, B. pumilus QST 2808, B. pumilus GHA 181, B. solisalsi AP-217, B. subtilis CX-9060, B. subtilis GB03, B. subtilis GB07, B. subtilis QST-713, B. subtilis var. amyloliquefaciens FZB24 and B. subtilis var. amyloliquefaciens D747. These mixtures are particularly suitable in soybean and corn, in particular for seed treatment.

According to a further embodiment, the at least one agent IC is selected from Streptomyces spp. Preferably from S. griseoviridis, S. lydicus and S. violaceusniger, in particular from strains S. griseoviridis K61, S. lydicus WYEC 108, S. violaceusniger XL-2 and S. violaceusniger YCED-9.

These mixtures are particularly suitable in soybean, cereals and corn, in particular corn especially to combat Fusarium head blight.

The present invention also relates to mixtures wherein the at least one agent IC is selected from the following yeasts and fungi: Ampelomyces quisqualis, in particular strain AQ 10, Aureobasidium pullulans, in particular blastospores of strain DSM14940 or blastospores of strain DSM 14941 or mixtures thereof; Candida oleophila, in particular strains I-182 and O, Coniothyrium minitans, in particular strain CON/M/91-8; Dilophosphora alopecuri which reduces annual ryegrass toxicity (ARGT), a disease of livestock resulting from the ingestion of annual ryegrass seed-heads that have been infected by the toxin producing bacterium Rathayibacter toxicus; Gliocladium catenulatum, in particular strain J 1446; Metschnikovia fructicola, in particular strain NRRL Y-30752, Microsphaeropsis ochracea, in particular strain P130A for control of apple scab; (2.13) Muscodor albus, in particular strain QST 20799, Pichia anomala, in particular strain WRL-076, Pseudozyma flocculosa, in particular strain PF-A22 UL; Pythium oligandrum, in particular strain DV74;

The present invention also relates to mixtures wherein the at least one agent IC is selected from the fungal genus Trichoderma, preferably from the strains Trichoderma asperellum T34, T. asperellum SKT-1, T. asperellum ICC 012, T. atroviride LC52, T. atroviride CNCM I-1237, T. gamsii ICC 080, T. harmatum TH 382, T. harzianum TH-35, T. harzianum T-22, T. harzianum T-39; mixture of T. harzianum ICC012 and T. viride ICC080; mixture of T. polysporum and T. harzianum; T. stromaticum, T. virens GL-21, T. virens G41 and T. viride TV1.

The present invention also relates to mixtures wherein the at least one agent IC is selected from the fungal genus Ulocladium, in particular U. oudemansii HRU3.

Preference is also given to mixtures comprising as agent IC a biopesticide from group L2), preferably selected from chitosan (hydrolysate), laminarin, Reynoutria sachlinensis extract and tea tree oil; even more preferable from laminarin.

Preference is also given to mixtures comprising as agent IC a biopesticide from group L3), preferably selected from Agrobacterium radiobacter K1026, Bacillus firmus I-1582, Bacillus thuringiensis ssp. kurstaki SB4, Beauveria bassiana GHA, B. bassiana H123, B. bassiana DSM 12256, B. bassiana PPRI 5339, Metarhizium anisopliae var. acridum IMI 330189, M. anisopliae FI-985, M. anisopliae FI-1045, M. anisopliae F52, M. anisopliae ICIPE 69, Paecilomyces lilacinus DSM 15169, P. lilacinus BCP2, Paenibacillus popilliae Dutky-1940 (NRRL B-2309=ATCC 14706), P. popilliae KLN 3 and P. popilliae Dutky 1, even more preferably from Bacillus thuringiensis ssp. kurstaki SB4, B. bassiana DSM 12256, B. bassiana PPRI 5339, Metarhizium anisopliae var. acridum IMI 330189, M. anisopliae FI-985, M. anisopliae FI-1045, Paecilomyces lilacinus DSM 15169, P. lilacinus BCP2, Paenibacillus popilliae Dutky-1940 (NRRL B-2309=ATCC 14706), P. popilliae KLN 3 and P. popilliae Dutky 1.

According to a further embodiment, the at least one agent IC is Beauveria bassiana, preferably selected from Beauveria bassiana ATCC 74040, B. bassiana GHA, B. bassiana H123, B. bassiana DSM 12256 and B. bassiana PPRI 5339, in particular Beauveria bassiana strain PPRI 5339. These mixtures are particularly suitable for wide range of arthropod pests, such as white flies, thrips, mites, aphids, tingids and all their developmental stages (eggs, immature stages, and adults) infesting numerous crops (vegetables, cucurbits, solanaceous fruits, strawberry, flowers and ornamentals, grapevine, citrus, pome, stone fruits, etc.). Recent studies have shown that these antagonistic fungal strains can effectively control also nut-weevils, wireworms (Agriotes spp.), and Tephritid flies, such as the Mediterranean fruit fly, Ceratitis capitata, the cherry fruit fly, Rhagoletis cerasi, and the olive fly, Bactrocera oleae. They are also useful in soybean and corn.

According to a further embodiment, the at least one agent IC is Beauveria brongniartii.

According to a further embodiment, the at least one agent IC is Metarhizium anisopliae or M. anisopliae var. acridium, preferably selected from M. anisopliae FI-1045, M. anisopliae F52, M. anisopliae var. acridum strains FI-985 and IMI 330189, in particular strain IMI 330189. These mixtures are particularly suitable for control of arthropod pests in soybean and corn.

According to a further embodiment, the at least one agent IC is Lecanicillium sp., preferably selected from Lecanicillium longisporum KV42, L. longisporum KV71 and L. muscarium (formerly Verticillium lecanii) KV01.

According to a further embodiment, the at least one agent IC is Paecilomyces fumosoroseus, preferably strain FE 9901 especially for white fly control.

According to a further embodiment, the at least one agent IC is selected from Nomuraea rileyi, preferably strains SA86101, GU87401, SR86151, CG128 and VA9101; and P. lilacinus, preferably strains 251, DSM 15169 or BCP2, in particular BCP2, which strains especially control the growth of plant-pathogenic nematodes.

According to a further embodiment, the at least one agent IC is Bacillus firmus, preferably spores of strain CNCM I-1582, preferable for seed treatment of soybean and corn against nematodes and insects.

According to a further embodiment, the at least one agent IC is B. cereus preferably spores of CNCM I-1562, preferable for seed treatment of soybean and corn against nematodes and insects.

According to a further embodiment, the at least one agent IC is a mixture of spores of B. firmus and B. cereus, preferably mixtures spores of strains CNCM I-1582 and CNCM I-1562, preferable for seed treatment of soybean and corn against nematodes and insects.

According to a further embodiment, the at least one agent IC is selected from Bacillus thuringiensis, preferably B. thuringiensis ssp. aizawai, in particular B. t. ssp. aizawai strains ABTS-18, SAN 401 I, ABG-6305 and ABG-6346, which are effective against different lepidopteran species including also noctuidae.

According to a further embodiment, the at least one agent IC is selected from Bacillus t. ssp. israelensis, preferably AM65-52, SAN 402 I and ABG-6164, which are applied against larvae of various dipteran pests, e.g. mosquitoes and nematoceres.

According to a further embodiment, the at least one agent IC is selected from Bacillus t. ssp. kurstaki preferably from strains EG 2348, SB4 and ABTS-351 (HD-1), in particular B. thuringiensis ssp. kurstaki SB4. These strains are used for control of lepidopteran larvae, but without noctuidae.

According to a further embodiment, the at least one agent IC is selected from Bacillus thuringiensis subsp. tenebrionis, preferably the strains DSM 2803, NB-125 and NB-176, in particular NB-176, which all protect plants e.g. against leaf beetle larvae.

Preference is also given to mixtures comprising as agent IC a biopesticide from group L4), preferably selected from, Acacia negra extract, extract of grapefruit seeds and pulp, Catnip oil, Neem oil, and Tagetes oil.

Preference is also given to mixtures comprising as agent IC a biopesticide from group L5), preferably selected from Azospirillum amazonense BR 11140 (SpY2T), A. brasilense XOH, A. brasilense BR 11005 (Sp245), A. brasilense BR 11002, A. lipoferum BR 11646 (Sp31), A. irakense, A. halopraeferens.

The present invention also relates to mixtures, wherein the at least one agent IC is selected from Azospirillum amazonense, A. brasilense, A. lipoferum, A. irakense and A. halopraeferens, more preferably from A. brasilense, in particular selected from A. brasilense strains BR 11005 (Sp245) and AZ39 which are both commercially used in Brazil and are obtainable from EMBRAPA-Agribiologia, Brazil. These mixtures are particularly suitable in soybean.

The present invention also relates to mixtures wherein the at least one agent IC is selected from A. amazonense, A. brasilense, A. lipoferum, A. irakense and A. halopraeferens, more preferably A. brasilense.

The present invention also relates to mixtures wherein the at least one agent IC is selected from R. leguminosarum bv. phaseolii, R. l. trifolii, R. l. bv. viciae, R. tropici and Sinorhizobium meliloti.

According to a further embodiment, the at least one agent IC is selected from Delftia acidovorans, in particular strain RAY209, especially in soybean and canola.

According to a further embodiment, the at least one agent IC is selected from Lysobacter spp., preferably selected from L. antibioticus, in particular strains 13-1 and HS124, preferably in rice or pepper for control of Phytophthora or bacterial leaf blight. According to a further embodiment, the at least one agent IC is selected from L. enzymogenes, in particular strain 3.1T8.

According to a further embodiment, the at least one agent IC is selected from Lysobacter spp., preferably selected from Pseudomonas spp., in particular strain MA 342 and Pseudomonas sp. DSM 13134.

According to a further embodiment, the at least one agent IC is selected from Penicillium bilaiae.

Preference is also given to mixtures comprise as agent IC a biopesticide from group L6), preferably selected from abscisic acid, aluminium silicate (kaolin), humates, Ascophyllum nodosum (Norwegian kelp, Brown kelp) extract and Ecklonia maxima (kelp) extract.

Preference is also given to mixtures comprise as agent IC a biopesticide selected from the isoflavones formonennitin, hesperetin and naringenin.

More preferred mixtures are those comprising compound II and fungicidal compound IA displayed in Table 1A:

In Table 1A, the following abbreviations are used:

jasmonic acid—No-1
methyl jasmonate—No-2
the jasmonate salt sodium jasmonate, potassium jasmonate, lithium jasmonate or ammonium jasmonate—No-3

| No | IA | II |
|---|---|---|
| M-1. | azoxystrobin | No-1 |
| M-2. | dimoxystrobin | No-1 |
| M-3. | fluoxastro [symbol] bin | No-1 |
| M-4. | kresoxim-methyl | No-1 |
| M-5. | orysastrobin | No-1 |
| M-6. | picoxy-strobin | No-1 |
| M-7. | pyraclostrobin | No-1 |
| M-8. | trifloxystrobin | No-1 |
| M-9. | cyazofamid | No-1 |
| M-10. | amisulbrom | No-1 |
| M-11. | bixafen | No-1 |
| M-12. | boscalid | No-1 |
| M-13. | carboxin | No-1 |
| M-14. | fluopyram | No-1 |
| M-15. | fluxapyroxad | No-1 |
| M-16. | isopyrazam | No-1 |
| M-17. | penflufen | No-1 |
| M-18. | penthiopyrad | No-1 |
| M-19. | sedaxane | No-1 |
| M-20. | N-(4′-trifluoromethylthiobiphenyl-2-yl)-3 difluoromethyl-1- | No-1 |
| | methyl-1H pyr [symbol] azole-4-carboxamide | |
| M-21. | N-(2-(1,3,3-trimethyl-butyl)-phenyl)-1,3-dimethyl-5 fluoro- | No-1 |
| | 1H-pyrazole-4 carboxamide, | |
| M-22. | N-[9-(dichloromethylene)-1,2,3,4-tetrahydro-1,4- | No-1 |
| | me [symbol] thanonaphthalen-5-yl]-3-(difluoromethyl)-1-methyl- | |
| | 1H-pyrazole-4-carboxamide, | |
| M-23. | 3 (difluoromethyl)-1-methyl-N-(1,1,3-trimethylindan-4- | No-1 |
| | yl)pyrazole-4-carboxamide, | |
| M-24. | 3 (trifluoromethyl)-1-methyl-N-(1,1,3-trimethylindan-4- | No-1 |
| | yl)pyrazole-4-carboxamide, | |
| M-25. | 1,3-dimethyl-N-(1,1,3-trimethylindan-4-yl)pyrazole-4- | No-1 |
| | carboxamide, | |
| M-26. | 3-(trifluorometh [symbol] yl)-1,5-dimethyl-N-(1,1,3- | No-1 |
| | trimethylindan-4-yl)pyrazole-4-carboxamide, | |
| M-27. | 3-(difluoro [symbol] methyl)-1,5-dimethyl-N-(1,1,3- | No-1 |
| | trimethylindan-4-yl)pyrazole-4-carboxamide, 1,3,5-- | |
| | tri [symbol] methylN-(1,1,3-trimethylindan-4-yl)pyrazole-4- | |
| | carboxamide, | |
| M-28. | ametoctradin | No-1 |
| M-29. | silthiofam | No-1 |
| M-30. | cyproconazole | No-1 |
| M-31. | epoxiconazole | No-1 |
| M-32. | fluquinconazole | No-1 |
| M-33. | ipconazole | No-1 |
| M-34. | metconazole | No-1 |
| M-35. | propiconazole | No-1 |
| M-36. | prothio [symbol] conazole | No-1 |
| M-37. | tebucona-zole | No-1 |
| M-38. | triadimenol | No-1 |
| M-39. | triticonazole | No-1 |
| M-40. | prochloraz | No-1 |
| M-41. | fenpropimorph | No-1 |
| M-42. | benalaxyl | No-1 |
| M-43. | benalaxyl-M | No-1 |
| M-44. | kiralaxyl | No-1 |
| M-45. | metalaxyl-M | No-1 |
| M-46. | metalaxyl | No-1 |
| M-47. | hymexazole | No-1 |
| M-48. | carbendazim | No-1 |
| M-49. | thiabendazole | No-1 |
| M-50. | thiophanate-methyl | No-1 |
| M-51. | ethaboxam | No-1 |
| M-52. | metrafenone | No-1 |
| M-53. | cyprodinil | No-1 |
| M-54. | pyrimethanil | No-1 |
| M-55. | iprodione | No-1 |
| M-56. | dimethomorph | No-1 |
| M-57. | man-cozeb | No-1 |
| M-58. | maneb | No-1 |
| M-59. | metiram | No-1 |
| M-60. | thiram | No-1 |
| M-61. | chlorothalonil | No-1 |
| M-62. | captan | No-1 |
| M-63. | dithianon | No-1 |
| M-64. | isotianil | No-1 |
| M-65. | tiadinil | No-1 |
| M-66. | pro-hexadione-calcium | No-1 |
| M-67. | triazoxide | No-1 |
| M-68. | azoxystrobin | No-2 |
| M-69. | dimoxystrobin | No-2 |
| M-70. | fluoxastro [symbol] bin | No-2 |
| M-71. | kresoxim-methyl | No-2 |
| M-72. | orysastrobin | No-2 |
| M-73. | picoxy-strobin | No-2 |
| M-74. | pyraclostrobin | No-2 |
| M-75. | trifloxystrobin | No-2 |
| M-76. | cyazofamid | No-2 |
| M-77. | amisulbrom | No-2 |
| M-78. | bixafen | No-2 |
| M-79. | boscalid | No-2 |
| M-80. | carboxin | No-2 |
| M-81. | fluopyram | No-2 |
| M-82. | fluxapyroxad | No-2 |
| M-83. | isopyrazam | No-2 |
| M-84. | penflufen | No-2 |
| M-85. | penthiopyrad | No-2 |
| M-86. | sedaxane | No-2 |
| M-87. | N-(4′-trifluoromethylthiobiphenyl-2-yl)-3 difluoromethyl-1- | No-2 |
| | methyl-1H pyr [symbol] azole-4-carboxamide | |
| M-88. | N-(2-(1,3,3-trimethyl-butyl)-phenyl)-1,3-dimethyl-5 fluoro- | No-2 |
| | 1H-pyrazole-4 carboxamide, | |
| M-89. | N-[9-(dichloromethylene)-1,2,3,4-tetrahydro-1,4- | No-2 |
| | me [symbol] thanonaphthalen-5-yl]-3-(difluoromethyl)-1-methyl- | |
| | 1H-pyrazole-4-carboxamide, | |
| M-90. | 3 (difluoromethyl)-1-methyl-N-(1,1,3-trimethylindan-4- | No-2 |
| | yl)pyrazole-4-carboxamide, | |
| M-91. | 3 (trifluoromethyl)-1-methyl-N-(1,1,3-trimethylindan-4- | No-2 |
| | yl)pyrazole-4-carboxamide, | |
| M-92. | 1,3-dimethyl-N-(1,1,3-trimethylindan-4-yl)pyrazole-4- | No-2 |
| | carboxamide, | |
| M-93. | 3-(trifluorometh [symbol] yl)-1,5-dimethyl-N-(1,1,3- | No-2 |
| | trimethylindan-4-yl)pyrazole-4-carboxamide, | |
| M-94. | 3-(difluoro [symbol] methyl)-1,5-dimethyl-N-(1,1,3- | No-2 |
| | trimethylindan-4-yl)pyrazole-4-carboxamide, 1,3,5- | |
| | tri [symbol] methyl-N-(1,1,3-trimethylindan-4-yl)pyrazole-4- | |
| | carboxamide, | |
| M-95. | ametoctradin | No-2 |
| M-96. | silthiofam | No-2 |
| M-97. | cyproconazole | No-2 |
| M-98. | epoxiconazole | No-2 |
| M-99. | fluquinconazole | No-2 |
| M-100. | ipconazole | No-2 |
| M-101. | metconazole | No-2 |
| M-102. | propiconazole | No-2 |
| M-103. | prothio [symbol] conazole | No-2 |
| M-104. | tebucona-zole | No-2 |
| M-105. | triadimenol | No-2 |
| M-106. | triticonazole | No-2 |
| M-107. | prochloraz | No-2 |
| M-108. | fenpropimorph | No-2 |
| M-109. | benalaxyl | No-2 |
| M-110. | benalaxyl-M | No-2 |
| M-111. | kiralaxyl | No-2 |
| M-112. | metalaxyl-M | No-2 |
| M-113. | metalaxyl | No-2 |
| M-114. | hymexazole | No-2 |
| M-115. | carbendazim | No-2 |
| M-116. | thiabendazole | No-2 |
| M-117. | thiophanate-methyl | No-2 |
| M-118. | ethaboxam | No-2 |
| M-119. | metrafenone | No-2 |
| M-120. | cyprodinil | No-2 |
| M-121. | pyrimethanil | No-2 |
| M-122. | iprodione | No-2 |
| M-123. | dimethomorph | No-2 |
| M-124. | man-cozeb | No-2 |
| M-125. | maneb | No-2 |
| M-126. | metiram | No-2 |
| M-127. | thiram | No-2 |
| M-128. | chlorothalonil | No-2 |
| M-129. | captan | No-2 |
| M-130. | dithianon | No-2 |
| M-131. | isotianil | No-2 |
| M-132. | tiadinil | No-2 |
| M-133. | pro-hexadione-calcium | No-2 |
| M-134. | triazoxide | No-2 |
| M-135. | azoxystrobin | No-3 |
| M-136. | dimoxystrobin | No-3 |
| M-137. | fluoxastro [symbol] bin | No-3 |
| M-138. | kresoxim-methyl | No-3 |
| M-139. | orysastrobin | No-3 |
| M-140. | picoxy-strobin | No-3 |
| M-141. | pyraclostrobin | No-3 |
| M-142. | trifloxystrobin | No-3 |
| M-143. | cyazofamid | No-3 |
| M-144. | amisulbrom | No-3 |
| M-145. | bixafen | No-3 |
| M-146. | boscalid | No-3 |
| M-147. | carboxin | No-3 |
| M-148. | fluopyram | No-3 |
| M-149. | fluxapyroxad | No-3 |
| M-150. | isopyrazam | No-3 |
| M-151. | penflufen | No-3 |
| M-152. | penthiopyrad | No-3 |
| M-153. | sedaxane | No-3 |
| M-154. | N-(4′-trifluoromethylthiobiphenyl-2-yl)-3 difluoromethyl-1- | No-3 |
| | methyl-1H pyr [symbol] azole-4-carboxamide | |
| M-155. | N-(2-(1,3,3-trimethyl-butyl)-phenyl)-1,3-dimethyl-5 fluoro- | No-3 |
| | 1H-pyrazole-4 carboxamide, | |
| M-156. | N-[9-(dichloromethylene)-1,2,3,4-tetrahydro-1,4- | No-3 |
| | me [symbol] thanonaphthalen-5-yl]-3-(difluoromethyl)-1-methyl- | |
| | 1H-pyrazole-4-carboxamide, | |
| M-157. | 3 (difluoromethyl)-1-methyl-N-(1,1,3-trimethylindan-4- | No-3 |
| | yl)pyrazole-4-carboxamide, | |
| M-158. | 3 (trifluoromethyl)-1-methyl-N-(1,1,3-trimethylindan-4- | No-3 |
| | yl)pyrazole-4-carboxamide, | |
| M-159. | 1,3-dimethyl-N-(1,1,3-trimethylindan-4-yl)pyrazole-4- | No-3 |
| | carboxamide, | |
| M-160. | 3-(trifluorometh [symbol] yl)-1,5-dimethyl-N-(1,1,3- | No-3 |
| | trimethylindan-4-yl)pyrazole-4-carboxamide, | |
| M-161. | 3-(difluoro [symbol] methyl)-1,5-dimethyl-N-(1,1,3- | No-3 |
| | trimethylindan-4-yl)pyrazole-4-carboxamide, 1,3,5- | |
| | tri [symbol] methyl-N-(1,1,3-trimethylindan-4-yl)pyrazole-4- | |
| | carboxamide, | |
| M-162. | ametoctradin | No-3 |
| M-163. | silthiofam | No-3 |
| M-164. | cyproconazole | No-3 |
| M-165. | epoxiconazole | No-3 |
| M-166. | fluquinconazole | No-3 |
| M-167. | ipconazole | No-3 |
| M-168. | metconazole | No-3 |
| M-169. | propiconazole | No-3 |
| M-170. | prothio [symbol] conazole | No-3 |
| M-171. | tebucona-zole | No-3 |
| M-172. | triadimenol | No-3 |
| M-173. | triticonazole | No-3 |
| M-174. | prochloraz | No-3 |
| M-175. | fenpropimorph | No-3 |
| M-176. | benalaxyl | No-3 |
| M-177. | benalaxyl-M | No-3 |
| M-178. | kiralaxyl | No-3 |
| M-179. | metalaxyl-M | No-3 |
| M-180. | metalaxyl | No-3 |
| M-181. | hymexazole | No-3 |
| M-182. | carbendazim | No-3 |
| M-183. | thiabendazole | No-3 |
| M-184. | thiophanate-methyl | No-3 |
| M-185. | ethaboxam | No-3 |
| M-186. | metrafenone | No-3 |
| M-187. | cyprodinil | No-3 |
| M-188. | pyrimethanil | No-3 |
| M-189. | iprodione | No-3 |
| M-190. | dimethomorph | No-3 |
| M-191. | man-cozeb | No-3 |
| M-192. | maneb | No-3 |
| M-193. | metiram | No-3 |
| M-194. | thiram | No-3 |
| M-195. | chlorothalonil | No-3 |
| M-196. | captan | No-3 |
| M-197. | dithianon | No-3 |
| M-198. | isotianil | No-3 |
| M-199. | tiadinil | No-3 |
| M-200. | pro-hexadione-calcium | No-3 |
| M-201. | triazoxide | No-3 |

Equally more preferred mixtures are those comprising compound II and compound IB displayed in Table 2A:

In Table 2A, the following abbreviations are used:

jasmonic acid—No.-1
methyl jasmonate—No. 2
the jasmonate salt sodium jasmonate, potassium jasmonate, lithium jasmonate or ammonium jasmonate—No-3

| No | IB | II |
|---|---|---|
| M-1. | carbofuran | No-1 |
| M-2. | carbosulfan | No-1 |
| M-3. | methiocarb | No-1 |
| M-4. | methomyl | No-1 |
| M-5. | thiodicarb | No-1 |
| M-6. | triazamate | No-1 |
| M-7. | acephate | No-1 |
| M-8. | chlorpyrifos | No-1 |
| M-9. | chlorpyrifos-methyl | No-1 |
| M-10. | dimethoate | No-1 |
| M-11. | methamidophos | No-1 |
| M-12. | ethiprole | No-1 |
| M-13. | fipronil, | No-1 |
| M-14. | 4-[5-[3-chloro-5-(trifluoromethyl)phenyl]-5- | No-1 |
| | (trifluoromethyl)-4H-isoxazol-3-yl]-N-[2-oxo-2-(2,2,2- | |
| | trifluoroethylamino)ethyl]naphthalene-1-carboxamide, | |
| M-15. | bifenthrin | No-1 |
| M-16. | cyfluthrin | No-1 |
| M-17. | beta-cyfluthrin | No-1 |
| M-18. | lambda-cyhalothrin | No-1 |
| M-19. | cypermethrin | No-1 |
| M-20. | alpha-cypermethrin | No-1 |
| M-21. | zeta-cypermethrin | No-1 |
| M-22. | deltamethrin | No-1 |
| M-23. | fenvalerate | No-1 |
| M-24. | flucythrinate | No-1 |
| M-25. | permethrin | No-1 |
| M-26. | tefluthrin | No-1 |
| M-27. | acteamiprid | No-1 |
| M-28. | chlothianidin | No-1 |
| M-29. | cycloxaprid | No-1 |
| M-30. | dinotefuran | No-1 |
| M-31. | flupyradifurone | No-1 |
| M-32. | imidacloprid | No-1 |
| M-33. | nitenpyram | No-1 |
| M-34. | sulfoxaflor | No-1 |
| M-35. | thiacloprid | No-1 |
| M-36. | thiamethoxam | No-1 |
| M-37. | 1-[(6-chloro-3-pyridyl)methyl]-7-methyl-8-nitro-5- | No-1 |
| | propoxy-3, 5, 6, 7-tetrahydro-2H-imidazo[1,2-a]pyridine | |
| M-38. | 2-a]pyridine | No-1 |
| M-39. | spinosad | No-1 |
| M-40. | spinetoram | No-1 |
| M-41. | abamectin | No-1 |
| M-42. | emamectin benzoate | No-1 |
| M-43. | bacillus thuringiensis | No-1 |
| M-44. | bacillus thuringiensis subsp. israelensis | No-1 |
| M-45. | bacillus sphaericus | No-1 |
| M-46. | bacillus thuringiensis subsp. aizawai | No-1 |
| M-47. | bacillus thuringiensis subsp. kurstaki | No-1 |
| M-48. | bacillus thuringiensis subsp. tenebrionis | No-1 |
| M-49. | Bt crop protein Cry1Ab, | No-1 |
| M-50. | Bt crop protein Cry1Ac, | No-1 |
| M-51. | Bt crop protein Cry1Fa | No-1 |
| M-52. | Bt crop protein Cry2Ab | No-1 |
| M-53. | Bt crop protein mCry3A | No-1 |
| M-54. | Bt crop protein Cry3Ab | No-1 |
| M-55. | Bt crop protein Cry3Bb | No-1 |
| M-56. | Bt crop protein Cry34/35Ab1 | No-1 |
| M-57. | chlorfenapyr | No-1 |
| M-58. | diflubenzuron | No-1 |
| M-59. | flufenoxuron | No-1 |
| M-60. | Inovaluron | No-1 |
| M-61. | teflubenzuron | No-1 |
| M-62. | tebufenpyrad | No-1 |
| M-63. | indoxacarb | No-1 |
| M-64. | metaflumizone | No-1 |
| M-65. | flubendiamide | No-1 |
| M-66. | chloranthraniliprole (rynaxypyr) | No-1 |
| M-67. | cyanthraniliprole (cyazypyr) | No-1 |
| M-68. | (R)-3-Chlor-N1-{2-methyl-4-[1,2,2,2-tetrafluor-1- | No-1 |
| | (trifluormethyl)ethyl]phenyl}-N2-(1-methy1-2- | |
| | methylsulfonylethyl)phthalamid | |
| M-69. | (S)-3-Chlor-N1-{2-methyl-4-[1,2,2,2-tetrafluor-1- | No-1 |
| | (trifluormethyl)ethyl]phenyl}-N2-(1-methyl-2- | |
| | methylsulfonylethyl)phthalamid | |
| M-70. | 3-bromo-N-{2-bromo-4-chloro-6-[(1- | No-1 |
| | cyclopropylethyl)carbamoyl]phenyl}-1-(3-chlorpyridin- | |
| | 2-yl)-1H-pyrazole-5-carboxamide | |
| M-71. | methyl-2-[3,5-dibromo-2-({[3-bromo-1-(3-chlorpyridin- | No-1 |
| | 2-yl)-1H-pyrazol-5-yl]carbonyl}amino)benzoyl]-1,2- | |
| | dimethylhydrazinecarboxylate | |
| M-72. | N2-[2-(3-chloro-2-pyridyl)-5-[(5-methyltetrazol-2- | No-1 |
| | yl)methyl]pyrazol-3-yl]-5-cyano-N1,3-dimethyl- | |
| | phthalamide | |
| M-73. | bacillus firmus strain “CNCM I-1582” | No-1 |
| M-74. | carbofuran | No-2 |
| M-75. | carbosulfan | No-2 |
| M-76. | methiocarb | No-2 |
| M-77. | methomyl | No-2 |
| M-78. | thiodicarb | No-2 |
| M-79. | triazamate | No-2 |
| M-80. | acephate | No-2 |
| M-81. | chlorpyrifos | No-2 |
| M-82. | chlorpyrifos-methyl | No-2 |
| M-83. | dimethoate | No-2 |
| M-84. | methamidophos | No-2 |
| M-85. | ethiprole | No-2 |
| M-86. | fipronil, | No-2 |
| M-87. | 4-[5-[3-chloro-5-(trifluoromethyl)phenyl]-5- | No-2 |
| | (trifluoromethyl)-4H-isoxazol-3-yl]-N-[2-oxo-2-(2,2,2- | |
| | trifluoroethylamino)ethyl]naphthalene-1-carboxamide, | |
| M-88. | bifenthrin | No-2 |
| M-89. | cyfluthrin | No-2 |
| M-90. | beta-cyfluthrin | No-2 |
| M-91. | lambda-cyhalothrin | No-2 |
| M-92. | cypermethrin | No-2 |
| M-93. | alpha-cypermethrin | No-2 |
| M-94. | zeta-cypermethrin | No-2 |
| M-95. | deltamethrin | No-2 |
| M-96. | fenvalerate | No-2 |
| M-97. | flucythrinate | No-2 |
| M-98. | permethrin | No-2 |
| M-99. | tefluthrin | No-2 |
| M-100. | acteamiprid | No-2 |
| M-101. | chlothianidin | No-2 |
| M-102. | cycloxaprid | No-2 |
| M-103. | dinotefuran | No-2 |
| M-104. | flupyradifurone | No-2 |
| M-105. | imidacloprid | No-2 |
| M-106. | nitenpyram | No-2 |
| M-107. | sulfoxaflor | No-2 |
| M-108. | thiacloprid | No-2 |
| M-109. | thiamethoxam | No-2 |
| M-110. | 1-[(6-chloro-3-pyridyl)methyl]-7-methyl-8-nitro-5- | No-2 |
| | propoxy-3, 5, 6, 7-tetrahydro-2H-imidazo[1,2-a]pyridine | |
| M-111. | 2-a]pyridine | No-2 |
| M-112. | spinosad | No-2 |
| M-113. | spinetoram | No-2 |
| M-114. | abamectin | No-2 |
| M-115. | emamectin benzoate | No-2 |
| M-116. | bacillus thuringiensis | No-2 |
| M-117. | bacillus thuringiensis subsp. israelensis | No-2 |
| M-118. | bacillus sphaericus | No-2 |
| M-119. | bacillus thuringiensis subsp. aizawai | No-2 |
| M-120. | bacillus thuringiensis subsp. kurstaki | No-2 |
| M-121. | bacillus thuringiensis subsp. tenebrionis | No-2 |
| M-122. | Bt crop protein Cry1Ab, | No-2 |
| M-123. | Bt crop protein Cry1Ac, | No-2 |
| M-124. | Bt crop protein Cry1Fa | No-2 |
| M-125. | Bt crop protein Cry2Ab | No-2 |
| M-126. | Bt crop protein mCry3A | No-2 |
| M-127. | Bt crop protein Cry3Ab | No-2 |
| M-128. | Bt crop protein Cry3Bb | No-2 |
| M-129. | Bt crop protein Cry34/35Ab1 | No-2 |
| M-130. | chlorfenapyr | No-2 |
| M-131. | diflubenzuron | No-2 |
| M-132. | flufenoxuron | No-2 |
| M-133. | Inovaluron | No-2 |
| M-134. | teflubenzuron | No-2 |
| M-135. | tebufenpyrad | No-2 |
| M-136. | indoxacarb | No-2 |
| M-137. | metaflumizone | No-2 |
| M-138. | flubendiamide | No-2 |
| M-139. | chloranthraniliprole (rynaxypyr) | No-2 |
| M-140. | cyanthraniliprole (cyazypyr) | No-2 |
| M-141. | (R)-3-Chlor-N1-{2-methyl-4-[1,2,2,2-tetrafluor-1- | No-2 |
| | (trifluormethyl)ethyl]phenyl}-N2-(1-methyl-2- | |
| | methylsulfonylethyl)phthalamid | |
| M-142. | (S)-3-Chlor-N1-{2-methyl-4-[1,2,2,2-tetrafluor-1- | No-2 |
| | (trifluormethyl)ethyl]phenyl}-N2-(1-methyl-2- | |
| | methylsulfonylethyl)phthalamid | |
| M-143. | 3-bromo-N-{2-bromo-4-chloro-6-[(1- | No-2 |
| | cyclopropylethyl)carbamoyl}phenyl]-1-(3-chlorpyridin- | |
| | 2-yl)-1H-pyrazole-5-carboxamide | |
| M-144. | methyl-2-[3,5-dibromo-2-({[3-bromo-1-(3-chlorpyridin- | No-2 |
| | 2-yl)-1H-pyrazol-5-yl]carbonyl}amino)benzoyl]-1,2- | |
| | dimethylhydrazinecarboxylate | |
| M-145. | N2-[2-(3-chloro-2-pyridyl)-5-[(5-methyltetrazol-2- | No-2 |
| | yl)methyl]pyrazol-3-yl]-5-cyano-N1,3-dimethyl- | |
| | phthalamide | |
| M-146. | bacillus firmus strain “CNCM I-1582” | No-2 |
| M-147. | carbofuran | No-3 |
| M-148. | carbosulfan | No-3 |
| M-149. | methiocarb | No-3 |
| M-150. | methomyl | No-3 |
| M-151. | thiodicarb | No-3 |
| M-152. | triazamate | No-3 |
| M-153. | acephate | No-3 |
| M-154. | chlorpyrifos | No-3 |
| M-155. | chlorpyrifos-methyl | No-3 |
| M-156. | dimethoate | No-3 |
| M-157. | methamidophos | No-3 |
| M-158. | ethiprole | No-3 |
| M-159. | fipronil, | No-3 |
| M-160. | 4-[5-[3-chloro-5-(trifluoromethyl)phenyl]-5- | No-3 |
| | (trifluoromethyl)-4H-isoxazol-3-yl]-N-[2-oxo-2-(2,2,2- | |
| | trifluoroethylamino)ethyl]naphthalene-1-carboxamide, | |
| M-161. | bifenthrin | No-3 |
| M-162. | cyfluthrin | No-3 |
| M-163. | beta-cyfluthrin | No-3 |
| M-164. | lambda-cyhalothrin | No-3 |
| M-165. | cypermethrin | No-3 |
| M-166. | alpha-cypermethrin | No-3 |
| M-167. | zeta-cypermethrin | No-3 |
| M-168. | deltamethrin | No-3 |
| M-169. | fenvalerate | No-3 |
| M-170. | flucythrinate | No-3 |
| M-171. | permethrin | No-3 |
| M-172. | tefluthrin | No-3 |
| M-173. | acteamiprid | No-3 |
| M-174. | chlothianidin | No-3 |
| M-175. | cycloxaprid | No-3 |
| M-176. | dinotefuran | No-3 |
| M-177. | flupyradifurone | No-3 |
| M-178. | imidacloprid | No-3 |
| M-179. | nitenpyram | No-3 |
| M-180. | sulfoxaflor | No-3 |
| M-181. | thiacloprid | No-3 |
| M-182. | thiamethoxam | No-3 |
| M-183. | 1-[(6-chloro-3-pyridyl)methyl]-7-methyl-8-nitro-5- | No-3 |
| | propoxy-3, 5, 6, 7-tetrahydro-2H-imidazo[1,2-a]pyridine | |
| M-184. | 2-a]pyridine | No-3 |
| M-185. | spinosad | No-3 |
| M-186. | spinetoram | No-3 |
| M-187. | abamectin | No-3 |
| M-188. | emamectin benzoate | No-3 |
| M-189. | bacillus thuringiensis | No-3 |
| M-190. | bacillus thuringiensis subsp. israelensis | No-3 |
| M-191. | bacillus sphaericus | No-3 |
| M-192. | bacillus thuringiensis subsp. aizawai | No-3 |
| M-193. | bacillus thuringiensis subsp. kurstaki | No-3 |
| M-194. | bacillus thuringiensis subsp. tenebrionis | No-3 |
| M-195. | Bt crop protein Cry1Ab, | No-3 |
| M-196. | Bt crop protein Cry1Ac, | No-3 |
| M-197. | Bt crop protein Cry1Fa | No-3 |
| M-198. | Bt crop protein Cry2Ab | No-3 |
| M-199. | Bt crop protein mCry3A | No-3 |
| M-200. | Bt crop protein Cry3Ab | No-3 |
| M-201. | Bt crop protein Cry3Bb | No-3 |
| M-202. | Bt crop protein Cry34/35Ab1 | No-3 |
| M-203. | chlorfenapyr | No-3 |
| M-204. | diflubenzuron | No-3 |
| M-205. | flufenoxuron | No-3 |
| M-206. | Inovaluron | No-3 |
| M-207. | teflubenzuron | No-3 |
| M-208. | tebufenpyrad | No-3 |
| M-209. | indoxacarb | No-3 |
| M-210. | metaflumizone | No-3 |
| M-211. | flubendiamide | No-3 |
| M-212. | chloranthraniliprole (rynaxypyr) | No-3 |
| M-213. | cyanthraniliprole (cyazypyr) | No-3 |
| M-214. | (R)-3-Chlor-N1-{2-methyl-4-[1,2,2,2-tetrafluor-1- | No-3 |
| | (trifluormethyl)ethyl]phenyl}-N2-(1-methyl-2- | |
| | methylsulfonylethyl)phthalamid | |
| M-215. | (S)-3-Chlor-N1-{2-methyl-4-[1,2,2,2-tetrafluor-1- | No-3 |
| | (trifluormethyl)ethyl]phenyl}-N2-(1-methyl-2- | |
| | methylsulfonylethyl)phthalamid | |
| M-216. | 3-bromo-N-{2-bromo-4-chloro-6-[(1- | No-3 |
| | cyclopropylethyl)carbamoyl]phenyl}-1-(3-chlorpyridin- | |
| | 2-yl)-1H-pyrazole-5-carboxamide | |
| M-217. | methyl-2[3,5-dibromo-2-({[3-bromo-1-(3-chlorpyridin- | No-3 |
| | 2-yl)-1H-pyrazol-5-yl]carbonyl}amino)benzoyl]-1,2- | |
| | dimethylhydrazinecarboxylate | |
| M-218. | N2-[2-(3-chloro-2-pyridyl)-5-[(5-methyltetrazol-2- | No-3 |
| | yl)methyl]pyrazol-3-yl]-5-cyano-N1,3-dimethyl- | |
| | phthalamide | |
| M-219. | bacillus firmus strain “CNCM I-1582” | No-3 |
| M-220. | afidopyropen | No-1 |
| M-221. | afidopyropen | No-2 |
| M-222. | afidopyropen | No-3 |

Most preferred mixtures are those comprising compound II and fungicidal compound IA displayed in Table 1B:

In Table 1B, the following abbreviations are used:

jasmonic acid—No.-1
methyl jasmonate—No. 2
the jasmonate salt sodium jasmonate, potassium jasmonate, lithium jasmonate or ammonium jasmonate—No-3

| No | IA | II |
|---|---|---|
| M-1. | azoxystrobin | No-1 |
| M-2. | dimoxystrobin | No-1 |
| M-3. | fluoxastrobin | No-1 |
| M-4. | kresoxim-methyl | No-1 |
| M-5. | orysastrobin | No-1 |
| M-6. | picoxystrobin | No-1 |
| M-7. | pyraclostrobin | No-1 |
| M-8. | trifloxystrobin | No-1 |
| M-9. | amisulbrom | No-1 |
| M-10. | bixafen | No-1 |
| M-11. | boscalid | No-1 |
| M-12. | fluopyram | No-1 |
| M-13. | fluxapyroxad | No-1 |
| M-14. | isopyrazam | No-1 |
| M-15. | penflufen | No-1 |
| M-16. | sedaxane | No-1 |
| M-17. | N-[9-(dichloromethylene)-1 | No-1 |
| M-18. | 2, 3, 4-tetrahydro-1, 4-methanonaphthalen-5-yl]-3- | No-1 |
| | (difluoromethyl)-1-methyl-1H-pyrazole-4-carboxamide | |
| M-19. | ametoctradin | No-1 |
| M-20. | silthiofam | No-1 |
| M-21. | epoxiconazole | No-1 |
| M-22. | fluquinconazole | No-1 |
| M-23. | ipconazole | No-1 |
| M-24. | metconazole | No-1 |
| M-25. | prothioconazole | No-1 |
| M-26. | tebuconazole | No-1 |
| M-27. | triticonazole | No-1 |
| M-28. | prochloraz | No-1 |
| M-29. | fenpropimorph | No-1 |
| M-30. | metalaxyl-M | No-1 |
| M-31. | metalaxyl | No-1 |
| M-32. | carbendazim | No-1 |
| M-33. | thiophanate-methyl | No-1 |
| M-34. | metrafenone | No-1 |
| M-35. | pyrimethanil | No-1 |
| M-36. | dimethomorph | No-1 |
| M-37. | mancozeb | No-1 |
| M-38. | metiram | No-1 |
| M-39. | dithianon | No-1 |
| M-40. | isotianil | No-1 |
| M-41. | tiadinil | No-1 |
| M-42. | prohexadione-calcium | No-1 |
| M-43. | azoxystrobin | No-2 |
| M-44. | di moxystrobin | No-2 |
| M-45. | fluoxastrobin | No-2 |
| M-46. | kresoxim-methyl | No-2 |
| M-47. | orysastrobin | No-2 |
| M-48. | picoxystrobin | No-2 |
| M-49. | pyraclostrobin | No-2 |
| M-50. | trifloxystrobin | No-2 |
| M-51. | amisulbrom | No-2 |
| M-52. | bixafen | No-2 |
| M-53. | boscalid | No-2 |
| M-54. | fluopyram | No-2 |
| M-55. | fluxapyroxad | No-2 |
| M-56. | isopyrazam | No-2 |
| M-57. | penflufen | No-2 |
| M-58. | sedaxane | No-2 |
| M-59. | N-[9-(dichloromethylene)-1 | No-2 |
| M-60. | 2, 3, 4-tetrahydro-1, 4-methanonaphthalen-5-yl]-3- | No-2 |
| | (difluoromethyl)-1-methyl-1H-pyrazole-4-carboxamide | |
| M-61. | ametoctrad in | No-2 |
| M-62. | silthiofam | No-2 |
| M-63. | epoxiconazole | No-2 |
| M-64. | fluquinconazole | No-2 |
| M-65. | ipconazole | No-2 |
| M-66. | metconazole | No-2 |
| M-67. | prothioconazole | No-2 |
| M-68. | tebuconazole | No-2 |
| M-69. | triticonazole | No-2 |
| M-70. | prochloraz | No-2 |
| M-71. | fenpropi morph | No-2 |
| M-72. | metalaxyl-M | No-2 |
| M-73. | metalaxyl | No-2 |
| M-74. | carbendazim | No-2 |
| M-75. | thiophanate-methyl | No-2 |
| M-76. | metrafenone | No-2 |
| M-77. | pyrimethanil | No-2 |
| M-78. | dimethomorph | No-2 |
| M-79. | mancozeb | No-2 |
| M-80. | metiram | No-2 |
| M-81. | dithianon | No-2 |
| M-82. | isotianil | No-2 |
| M-83. | tiadinil | No-2 |
| M-84. | prohexadione-calcium | No-2 |
| M-85. | azoxystrobin | No-3 |
| M-86. | dimoxystrobin | No-3 |
| M-87. | fluoxastrobin | No-3 |
| M-88. | kresoxim-methyl | No-3 |
| M-89. | orysastrobin | No-3 |
| M-90. | picoxystrobin | No-3 |
| M-91. | pyraclostrobin | No-3 |
| M-92. | trifloxystrobin | No-3 |
| M-93. | amisulbrom | No-3 |
| M-94. | bixafen | No-3 |
| M-95. | boscalid | No-3 |
| M-96. | fluopyram | No-3 |
| M-97. | fluxapyroxad | No-3 |
| M-98. | isopyrazam | No-3 |
| M-99. | penflufen | No-3 |
| M-100. | sedaxane | No-3 |
| M-101. | N-[9-(dichloromethylene)-1 | No-3 |
| M-102. | 2, 3, 4-tetrahydro-1, 4-methanonaphthalen-5-yl]-3- | No-3 |
| | (difluoromethyl)-1-methyl-1H-pyrazole-4-carboxamide | |
| M-103. | ametoctradin | No-3 |
| M-104. | silthiofam | No-3 |
| M-105. | epoxiconazole | No-3 |
| M-106. | fluquinconazole | No-3 |
| M-107. | ipconazole | No-3 |
| M-108. | metconazole | No-3 |
| M-109. | prothioconazole | No-3 |
| M-110. | tebuconazole | No-3 |
| M-111. | triticonazole | No-3 |
| M-112. | prochloraz | No-3 |
| M-113. | fenpropimorph | No-3 |
| M-114. | metalaxyl-M | No-3 |
| M-115. | metalaxyl-M | No-3 |
| M-116. | metalaxyl | No-3 |
| M-117. | carbendazim | No-3 |
| M-118. | thiophanate-methyl | No-3 |
| M-119. | metrafenone | No-3 |
| M-120. | pyrimethanil | No-3 |
| M-121. | dimethomorph | No-3 |
| M-122. | mancozeb | No-3 |
| M-123. | metiram | No-3 |
| M-124. | dithianon | No-3 |
| M-125. | isotianil | No-3 |
| M-126. | tiadinil | No-3 |
| M-127. | prohexadione-calcium | No-3 |

Equally most preferred mixtures are those comprising compound II and compound IB displayed in Table 2B:

In Table 2B, the following abbreviations are used:

jasmonic acid—No.-1
methyl jasmonate—No. 2
the jasmonate salt sodium jasmonate, potassium jasmonate, lithium jasmonate or ammonium jasmonate—No-3

| No | IB | II |
|---|---|---|
| M-1. | thiodicarb | No-1 |
| M-2. | ethiprole | No-1 |
| M-3. | fipronil | No-1 |
| M-4. | lambda-cyhalothrin | No-1 |
| M-5. | alpha-cypermethrin | No-1 |
| M-6. | fenvalerate | No-1 |
| M-7. | permethrin | No-1 |
| M-8. | acteamiprid | No-1 |
| M-9. | chlothianidin | No-1 |
| M-10. | cycloxaprid | No-1 |
| M-11. | dinotefuran | No-1 |
| M-12. | flu pyrad ifurone | No-1 |
| M-13. | imidacloprid | No-1 |
| M-14. | nitenpyram | No-1 |
| M-15. | sulfoxaflor | No-1 |
| M-16. | thiacloprid | No-1 |
| M-17. | thiamethoxam | No-1 |
| M-18. | spinosad | No-1 |
| M-19. | abamectin | No-1 |
| M-20. | emamectin benzoate | No-1 |
| M-21. | bacillus thuringiensis | No-1 |
| M-22. | bacillus thuringiensis subsp. israelensis | No-1 |
| M-23. | bacillus sphaericus | No-1 |
| M-24. | bacillus thuringiensis subsp. aizawai | No-1 |
| M-25. | bacillus thuringiensis subsp. kurstaki | No-1 |
| M-26. | bacillus thuringiensis subsp. tenebrionis | No-1 |
| M-27. | Bt crop protein Cry1Ab | No-1 |
| M-28. | Bt crop protein Cry1Ac | No-1 |
| M-29. | Bt crop protein Cry1Fa | No-1 |
| M-30. | Bt crop protein Cry2Ab | No-1 |
| M-31. | Bt crop protein mCry3A | No-1 |
| M-32. | Bt crop protein Cry3Ab | No-1 |
| M-33. | Bt crop protein Cry3Bb | No-1 |
| M-34. | Bt crop protein Cry34/35Ab1 | No-1 |
| M-35. | chlorfenapyr | No-1 |
| M-36. | flufenoxuron | No-1 |
| M-37. | teflubenzuron | No-1 |
| M-38. | metaflumizone | No-1 |
| M-39. | flubendiamide | No-1 |
| M-40. | chloranthraniliprole (rynaxypyr) | No-1 |
| M-41. | cyanthraniliprole (cyazypyr) | No-1 |
| M-42. | thiodicarb | No-2 |
| M-43. | ethiprole | No-2 |
| M-44. | fipronil | No-2 |
| M-45. | lambda-cyhalothrin | No-2 |
| M-46. | alpha-cypermethrin | No-2 |
| M-47. | fenvalerate | No-2 |
| M-48. | permethrin | No-2 |
| M-49. | acteamiprid | No-2 |
| M-50. | chlothianidin | No-2 |
| M-51. | cycloxaprid | No-2 |
| M-52. | dinotefuran | No-2 |
| M-53. | flupyradifurone | No-2 |
| M-54. | imidacloprid | No-2 |
| M-55. | nitenpyram | No-2 |
| M-56. | sulfoxaflor | No-2 |
| M-57. | thiacloprid | No-2 |
| M-58. | thiamethoxam | No-2 |
| M-59. | spinosad | No-2 |
| M-60. | abamectin | No-2 |
| M-61. | emamectin benzoate | No-2 |
| M-62. | bacillus thuringiensis | No-2 |
| M-63. | bacillus thuringiensis subsp. israelensis | No-2 |
| M-64. | bacillus sphaericus | No-2 |
| M-65. | bacillus thuringiensis subsp. aizawai | No-2 |
| M-66. | bacillus thuringiensis subsp. kurstaki | No-2 |
| M-67. | bacillus thuringiensis subsp. tenebrionis | No-2 |
| M-68. | Bt crop protein Cry1Ab | No-2 |
| M-69. | Bt crop protein Cry1Ac | No-2 |
| M-70. | Bt crop protein Cry1Fa | No-2 |
| M-71. | Bt crop protein Cry2Ab | No-2 |
| M-72. | Bt crop protein mCry3A | No-2 |
| M-73. | Bt crop protein Cry3Ab | No-2 |
| M-74. | Bt crop protein Cry3Bb | No-2 |
| M-75. | Bt crop protein Cry34/35Ab1 | No-2 |
| M-76. | chlorfenapyr | No-2 |
| M-77. | flufenoxuron | No-2 |
| M-78. | teflubenzuron | No-2 |
| M-79. | metaflumizone | No-2 |
| M-80. | flubendiamide | No-2 |
| M-81. | chloranthraniliprole (rynaxypyr) | No-2 |
| M-82. | cyanthraniliprole (cyazypyr) | No-2 |
| M-83. | thiodicarb | No-3 |
| M-84. | ethiprole | No-3 |
| M-85. | fipronil | No-3 |
| M-86. | lambda-cyhalothrin | No-3 |
| M-87. | alpha-cypermethrin | No-3 |
| M-88. | fenvalerate | No-3 |
| M_89. | permethrin | No-3 |
| M-90. | acteamiprid | No-3 |
| M-91. | chlothianidin | No-3 |
| M-92. | cycloxaprid | No-3 |
| M-93. | dinotefuran | No-3 |
| M-94. | flupyradifurone | No-3 |
| M-95. | imidacloprid | No-3 |
| M-96. | nitenpyram | No-3 |
| M-97 . | sulfoxaflor | No-3 |
| M-98. | thiacloprid | No-3 |
| M-99. | thiamethoxam | No-3 |
| M-100. | spinosad | No-3 |
| M-101. | abamectin | No-3 |
| M-102. | emamectin benzoate | No-3 |
| M-103. | bacillus thuringiensis | No-3 |
| M-104. | bacillus thuringiensis subsp. israelensis | No-3 |
| M-105. | bacillus sphaericus | No-3 |
| M-106. | bacillus thuringiensis subsp. aizawai | No-3 |
| M-107. | bacillus thuringiensis subsp. kurstaki | No-3 |
| M-108. | bacillus thuringiensis subsp. tenebrionis | No-3 |
| M-109. | Bt crop protein Cry1Ab | No-3 |
| M-110. | Bt crop protein Cry1Ac | No-3 |
| M-111. | Bt crop protein Cry1Fa | No-3 |
| M-112. | Bt crop protein Cry2Ab | No-3 |
| M-113. | Bt crop protein mCry3A | No-3 |
| M-114. | Bt crop protein Cry3Ab | No-3 |
| M-115. | Bt crop protein Cry3Bb | No-3 |
| M-116. | Bt crop protein Cry34/35Ab1 | No-3 |
| M-117. | chlorfenapyr | No-3 |
| M-118. | flufenoxuron | No-3 |
| M-119. | teflubenzuron | No-3 |
| M-120. | metaflumizone | No-3 |
| M-121. | flubendiamide | No-3 |
| M-122. | chloranthraniliprole (rynaxypyr) | No-3 |
| M-123. | cyanthraniliprole (cyazypyr) | No-3 |

Equally most preferred mixtures are those comprising compound II and compound IC displayed in Table 3B:

In Table 3B, the following abbreviations are used:

jasmonic acid—No-1
methyl jasmonate—No-2
the jasmonate salt sodium jasmonate, potassium jasmonate, lithium jasmonate or ammonium jasmonate—No-3

| No | IC | II |
|---|---|---|
| M-1. | Ampelomyces quisqualis | No-1 |
| M-2. | Aspergillus flavus | No-1 |
| M-3. | Aureobasidium pullulans | No-1 |
| M-4. | Bacillus pumilus | No-1 |
| M-5. | Bacillus pumilus NRRL Accession No. B-30087 | No-1 |
| M-6. | Bacillus subtilis | No-1 |
| M-7. | Bacillus subtilis isolate NRRL-Nr. B-21661 | No-1 |
| M-8. | Bacillus amyloliquefaciens AP-136 (NRRL B-50614) | No-1 |
| M-9. | Bacillus subtilis var. amyloliquefaciens FZB24 | No-1 |
| M-10. | Bacillus amyloliquefaciens AP-188 (NRRL B-50615) | No-1 |
| M-11. | Candida oleophila I-82 | No-1 |
| M-12. | Candida saitoana | No-1 |
| M-13. | Chitosan | No-1 |
| M-14. | Coniothyrium minitans | No-1 |
| M-15. | Cryphonectria parasitica | No-1 |
| M-16. | Cryptococcus albidus | No-1 |
| M-17. | Fusarium oxysporum | No-1 |
| M-18. | FUSACLEAN ® | No-1 |
| M-19. | Microdochium dimerum | No-1 |
| M-20. | Pseudozyma flocculosa | No-1 |
| M-21. | Reynoutria sachlinensis | No-1 |
| M-22. | Talaromyces flavus V117b | No-1 |
| M-23. | Trichoderma asperellum SKT-1 | No-1 |
| M-24. | T. atroviride LC52 | No-1 |
| M-25. | T. harzianum T-22 | No-1 |
| M-26. | T. harzianum T-39 | No-1 |
| M-27. | T. harzianum | No-1 |
| M-28. | T. viride | No-1 |
| M-29. | T. harzianum ICC012 | No-1 |
| M-30. | T. viride ICC080 | No-1 |
| M-31. | T. stromaticum | No-1 |
| M-32. | T. virens GL-21 | No-1 |
| M-33. | T. viride BIO-CURE ® F | No-1 |
| M-34. | Ulocladium oudemansii HRU3 | No-1 |
| M-35. | Ampelomyces quisqualis | No-2 |
| M-36. | Aspergillus flavus | No-2 |
| M-37. | Aureobasidium pullulans | No-2 |
| M-38. | Bacillus pumilus | No-2 |
| M-39. | Bacillus pumilus NRRL Accession No. B-30087 | No-2 |
| M-40. | Bacillus subtilis | No-2 |
| M-41. | Bacillus subtilis isolate NRRL-Nr. B-21661 | No-2 |
| M-42. | Bacillus amyloliquefaciens AP-136 (NRRL B-50614) | No-2 |
| M-43. | Bacillus subtilis var. amyloliquefaciens FZB24 | No-2 |
| M-44. | Bacillus amyloliquefaciens AP-188 (NRRL B-50615) | No-2 |
| M-45. | Candida oleophila I-82 | No-2 |
| M-46. | Candida saitoana | No-2 |
| M-47. | Chitosan | No-2 |
| M-48. | Coniothyrium minitans | No-2 |
| M-49. | Cryphonectria parasitica | No-2 |
| M-50. | Cryptococcus albidus | No-2 |
| M-51. | Fusarium oxysporum | No-2 |
| M-52. | FUSACLEAN ® | No-2 |
| M-53. | Microdochium dimerum | No-2 |
| M-54. | Pseudozyma tiocculosa | No-2 |
| M-55. | Reynoutria sachlinensis | No-2 |
| M-56. | Talaromyces flavus V117b | No-2 |
| M-57. | Trichoderma asperellum SKT-1 | No-2 |
| M-58. | T. atroviride LC52 | No-2 |
| M-59. | T. harzianum T-22 | No-2 |
| M-60. | T. harzianum T-39 | No-2 |
| M-61. | T. harzianum | No-2 |
| M-62. | T. viride | No-2 |
| M-63. | T. harzianum ICC012 | No-2 |
| M-64. | T. viride ICC080 | No-2 |
| M-65. | T. stromaticum | No-2 |
| M-66. | T. virens GL-21 | No-2 |
| M-67. | T. viride BIO-CURE ® F | No-2 |
| M-68. | Ulocladium oudemansii HRU3 | No-2 |
| M-69. | Ampelomyces quisqualis | No-3 |
| M-70. | Aspergillus flavus | No-3 |
| M-71. | Aureobasidium pullulans | No-3 |
| M-72. | Bacillus pumilus | No-3 |
| M-73. | Bacillus pumilus NRRL Accession No. B-30087 | No-3 |
| M-74. | Bacillus subtilis | No-3 |
| M-75. | Bacillus subtilis isolate NRRL-Nr. B-21661 | No-3 |
| M-76. | Bacillus amyloliquefaciens AP-136 (NRRL B-50614) | No-3 |
| M-77. | Bacillus subtilis var. amyloliquefaciens FZB24 | No-3 |
| M-78. | Bacillus amyloliquefaciens AP-188 (NRRL B-50615) | No-3 |
| M-79. | Candida oleophila I-82 | No-3 |
| M-80. | Candida saitoana | No-3 |
| M-81. | Chitosan | No-3 |
| M-82. | Coniothyrium minitans | No-3 |
| M-83. | Cryphonectria parasitica | No-3 |
| M-84. | Cryptococcus albidus | No-3 |
| M-85. | Fusarium oxysporum | No-3 |
| M-86. | FUSACLEAN ® | No-3 |
| M-87. | Microdochium dimerum | No-3 |
| M-88. | Pseudozyma flocculosa | No-3 |
| M-89. | Reynoutria sachlinensis | No-3 |
| M-90. | Talaromyces flavus V117b | No-3 |
| M-91. | Trichoderma asperellum SKT-1 | No-3 |
| M-92. | T. atroviride LC52 | No-3 |
| M-93. | T. harzianum T-22 | No-3 |
| M-94. | T. harzianum T-39 | No-3 |
| M-95. | T. harzianum | No-3 |
| M-96. | T. viride | No-3 |
| M-97. | T. harzianum ICC012 | No-3 |
| M-98. | T. viride ICC080 | No-3 |
| M-99. | T. stromaticum | No-3 |
| M-100. | T. virens GL-21 | No-3 |
| M-101. | T. viride BIO-CURE ® F | No-3 |
| M-102. | Ulocladium oudemansii HRU3 | No-3 |
| M-103. | Bacillus amyloliquefaciens | No-1 |
| M-104. | Bacillus amyloliquefaciens | No-2 |
| M-105. | Bacillus amyloliquefaciens | No-3 |
| M-106. | Bacillus amyloliquefaciens AP-218 (NRRL B-50618) | No-1 |
| M-107. | Bacillus amyloliquefaciens AP-218 (NRRL B-50618) | No-2 |
| M-108. | Bacillus amyloliquefaciens AP-218 (NRRL B-50618) | No-3 |
| M-109. | Bacillus amyloliquefaciens AP-219 (NRRL B-50619) | No-1 |
| M-110. | Bacillus amyloliquefaciens AP-219 (NRRL B-50619) | No-2 |
| M-111. | Bacillus amyloliquefaciens AP-219 (NRRL B-50619) | No-3 |
| M-112. | Bacillus amyloliquefaciens AP-295 (NRRL B-50620) | No-1 |
| M-113. | Bacillus amyloliquefaciens AP-295 (NRRL B-50620) | No-2 |
| M-114. | Bacillus amyloliquefaciens AP-295 (NRRL B-50620) | No-3 |
| M-115. | Bacillus amyloliquefaciens FZB42 | No-1 |
| M-116. | Bacillus amyloliquefaciens FZB42 | No-2 |
| M-117. | Bacillus amyloliquefaciens FZB42 | No-3 |
| M-118. | Bacillus amyloliquefaciens IN937a | No-1 |
| M-119. | Bacillus amyloliquefaciens IN937a | No-2 |
| M-120. | Bacillus amyloliquefaciens IN937a | No-3 |
| M-121. | Bacillus amyloliquefaciens IT-45 (CNCM I-3800) | No-1 |
| M-122. | Bacillus amyloliquefaciens IT-45 (CNCM I-3800) | No-2 |
| M-123. | Bacillus amyloliquefaciens IT-45 (CNCM I-3800) | No-3 |

In a preferred embodiment, the invention relates to a method for protection of plant propagation material (preferably seed) from fungi and/or increasing the resistance of plants against biotic stress comprising contacting the plant propagation materials (preferably seeds) with an inventive mixture, wherein the mixture comprises to a row of Table 1A.

In a further preferred embodiment, the invention relates to a method for protection of plant propagation material (preferably seed) from insect and/or increasing the resistance of plants against biotic stress comprising contacting the plant propagation materials (preferably seeds) with an inventive mixture, wherein the mixture comprises to a row of Table 1B.

In a more preferred embodiment, the invention relates to a method for protection of plant propagation material (preferably seed) from fungi and/or increasing the resistance of plants against biotic stress comprising contacting the plant propagation materials (preferably seeds) with an inventive mixture, wherein the mixture comprises to a row of Table 2A.

In a more further preferred embodiment, the invention relates to a method for protection of plant propagation material (preferably seed) from insect and/or increasing the resistance of plants against biotic stress comprising contacting the plant propagation materials (preferably seeds) with an inventive mixture, wherein the mixture comprises to a row of Table 2B.

In a most preferred embodiment, the invention relates to a method for protection of plant propagation material (preferably seed) from fungi and/or increasing the resistance of plants against biotic stress comprising contacting the plant propagation materials (preferably seeds) with an inventive mixture, wherein the mixture comprises to a row of Table 3A.

In a further most preferred embodiment, the invention relates to a method for protection of plant propagation material (preferably seed) from fungi and/or increasing the resistance of plants against biotic stress comprising contacting the plant propagation materials (preferably seeds) with an inventive mixture, wherein the mixture comprises to a row of Table 3B.

In a further most preferred embodiment, the invention relates to a method for protection of plant propagation material (preferably seed) from insect and/or increasing the resistance of plants against biotic stress comprising contacting the plant propagation materials (preferably seeds) with an inventive mixture, wherein the mixture comprises to a row of Table 3B.

The inventive mixtures comprising compound II and as agent IC a microbial pesticide from groups L1), L3) and L5) may be formulated as an inoculant for a plant. The term “inoculant” means a preparation that includes an isolated culture of a microbial pesticide and optionally a carrier, which may include a biologically acceptable medium.

According to one embodiment, the microbial pesticides selected from groups L1), L3) and L5) embrace not only the isolated, pure cultures of the respective micro-organism as defined herein, but also its cell-free extract, its suspensions in a whole broth culture or as a metabolite-containing supernatant or a purified metabolite obtained from a whole broth culture of the microorganism or microorganism strain.

According to a further embodiment, the microbial pesticides selected from groups L1), L3) and L5) embraces not only the isolated, pure cultures of the respective micro-organism as defined herein, but also a cell-free extract thereof or at least one metabolite thereof, and/or a mutant of the respective micro-organism having all the identifying characteristics thereof and also a cell-free extract or at least one metabolite of the mutant.

The abovementioned microbial pesticides from groups L1), L3) and L5) may be isolated or substantially purified. The terms “isolated” or “substantially purified” refers to microbial pesticides that have been removed from a natural environment and have been isolated or separated, and are at least 60% free, preferably at least 75% free, and more preferably at least 90% free, even more preferably at least 95% free, and most preferably at least 100% free from other components with which they were naturally associated. An “isolated culture” or “substantially purified culture” refers to a culture of the microbial pesticides that does not include significant amounts of other materials such as other materials which normally are found in natural habitat in which the microbial pesticides grows and/or from which the microbial pesticides normally may be obtained. An “isolated culture” may be a culture that does not include any other biological, microorganism, and/or bacterial species in quantities sufficient to interfere with the replication of the isolated culture. Isolated cultures of microbial pesticides may, however, be combined to prepare a mixed culture of microbial pesticides.

Herein, microbial pesticides may be supplied in any physiological state such as active or dormant. Dormant microbial pesticides may be supplied for example frozen, dried, or lyophilized or partly desiccated (procedures to produce partly desiccated organisms are given in WO 2008/002371) or in form of spores.

Agents IC which are microbial pesticides II selected from groups L1), L3) and L5) used as organism in an active state can be delivered in a growth medium without any additional additives or materials or in combination with suitable nutrient mixtures.

In a further particular preferred embodiment, the invention relates to a method for protection of plant propagation material (preferably seed) from fungi and/or increasing the resistance of plants against biotic stress protection of plant propagation material (preferably seed) from fungi and/or increasing the resistance of plants against biotic stress comprising contacting the plant propagation materials (preferably seeds) with an inventive mixture, comprise of pyraclostrobin as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of pyraclostrobin as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of pyraclostrobin as compound IA and jasmonic acid methyl ester in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of fluxapyroxad as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of fluxapyroxad as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of fluxapyroxad as compound IA and jasmonate salt (jasmonate salts, e.g., potassium jasmonate, sodium jasmonate, lithium jasmonate or ammonium jasmonate) in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of azoxystrobin as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of azoxystrobin as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of azoxystrobin as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of boscalid as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of boscalid as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of boscalid as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of metalaxyl as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of p metalaxyl as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of metalaxyl as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of metalaxyl-M as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of p metalaxyl-M as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of metalaxyl-M as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of penflufen as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of p penflufen as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of penflufen as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of pyrimethanil as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of p pyrimethanil as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of pyrimethanil as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of sedaxane as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of p sedaxane as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of sedaxane as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of silthiofarm as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of silthiofarm as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of silthiofarm as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of thiophanate-methyl as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of thiophanate-methyl as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of thiophanate-methyl as compound IA and jasmonic acid methyl ester in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of triticonazole as compound IA and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of triticonazole as compound IA and jasmonic acid in pesticidally effective amounts.

In a further particular preferred embodiment, the invention relates to a method for protection of plant propagation material (preferably seed) from fungi and/or increasing the resistance of plants against biotic stress comprising contacting the plant propagation materials (preferably seeds) with an inventive mixture comprise of triticonazole as compound IA and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of fipronil as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of fipronil as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of fipronil as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of alpha-cypermethrin as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of alpha-cypermethrin as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of acetamiprid as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of acetamiprid as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of acetamiprid as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of acetamiprid as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of clothianidin as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of clothianidin as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of clothianidin as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of dinotefuran as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of dinotefuran as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of dinotefuran as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of imidacloprid as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of imidacloprid as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of imidacloprid as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of sulfoxaflor as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of sulfoxaflor as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of sulfoxaflor as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of thiamethoxam as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of thiamethoxam as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of thiamethoxam as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of abamectin as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of abamectin as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of abamectin as compound IB and jasmonic acid methyl ester in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of ememctin benzoate as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of ememctin benzoate as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of ememctin benzoate as compound IB and jasmonic acid methyl ester in pesticidally effective amounts.

protection of plant propagation material (preferably seed) from insects and/or increasing the resistance of plants against biotic stress comprising contacting the plant propagation materials (preferably seeds) with an inventive mixture comprise of bacillus thuringiensis as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of bacillus thuringiensis as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of bacillus thuringiensis as compound IB and jasmonic acid methyl ester in pesticidally effective amounts.

protection of plant propagation material (preferably seed) from insects and/or increasing the resistance of plants against biotic stress comprising contacting the plant propagation materials (preferably seeds) with an inventive mixture comprise of chloranthraniliprole as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of chloranthraniliprole as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of chloranthraniliprole as compound IB and jasmonic acid methyl ester in pesticidally effective amounts. protection of plant propagation material (preferably seed) from insects and/or increasing the resistance of plants against biotic stress comprising contacting the plant propagation materials (preferably seeds) with an inventive mixture comprise of cyanthraniliprole as compound IB and jasmonate salt (jasmonate salts, e.g., potassium jasmonate, sodium jasmonate, lithium jasmonate or ammonium jasmonate) in pesticidally effective amounts.

In a particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of cyanthraniliprole as compound IB and jasmonic acid in pesticidally effective amounts.

In a further particular preferred embodiment, the invention relates to a method for protection of plant propagation material (preferably seed) from insects and/or increasing the resistance of plants against biotic stress comprising contacting the plant propagation materials (preferably seeds) with an inventive mixture comprise of cyanthraniliprole as compound IB and jasmonic acid methyl ester in pesticidally effective amounts.

The inventive mixtures can further contain one or more insecticides, fungicides, herbicides.

The inventive mixtures can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.)

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B—C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the inventive mixtures on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), an organic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for composition types and their preparation are:

i) Water-soluble concentrates (SL, LS)

10-60 wt % of an inventive mixture and 5-15 wt % wetting agent (e.g. alcohol alkoxylates) are dissolved in water and/or in a water-soluble solvent (e.g. alcohols) ad 100 wt %. The active substance dissolves upon dilution with water.

ii) Dispersible concentrates (DC)

5-25 wt % of an inventive mixture and 1-10 wt % dispersant (e. g. polyvinylpyrrolidone) are dissolved in organic solvent (e.g. cyclohexanone) ad 100 wt %. Dilution with water gives a dispersion

iii) Emulsifiable concentrates (EC)

15-70 wt % of an inventive mixture and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.

### iv) Emulsions (EW, EO, ES)

5-40 wt % of an inventive mixture and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of an inventive mixture are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.

vi) Water-dispersible granules and water-soluble granules (WG, SG)

50-80 wt % of an inventive mixture are ground finely with addition of dispersants and wetting agents (e.g. sodium lignosulfonate and alcohol ethoxylate) ad 100 wt % and prepared as water-dispersible or water-soluble granules by means of technical appliances (e. g. extrusion, spray tower, fluidized bed). Dilution with water gives a stable dispersion or solution of the active substance.

vii) Water-dispersible powders and water-soluble powders (WP, SP, WS)

50-80 wt % of an inventive mixture are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.

viii) Gel (GW, GF)

In an agitated ball mill, 5-25 wt % of an inventive mixture are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.

### ix) Microemulsion (ME)

5-20 wt % of an inventive mixture are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.

### x) Microcapsules (CS)

An oil phase comprising 5-50 wt % of an inventive mixture, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of an inventive mixture according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS composition.

xi) Dustable powders (DP, DS)

1-10 wt % of an inventive mixture are ground finely and mixed intimately with solid carrier (e.g. finely divided kaolin) ad 100 wt %.

xii) Granules (GR, FG)

0.5-30 wt % of an inventive mixture is ground finely and associated with solid carrier (e.g. silicate) ad 100 wt %. Granulation is achieved by extrusion, spray-drying or fluidized bed.

xiii) Ultra-low volume liquids (UL)

1-50 wt % of an inventive mixture are dissolved in organic solvent (e.g. aromatic hydrocarbon) ad 100 wt %.

The compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The resulting agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40%, in the ready-to-use preparations. Application can be carried out before or during sowing. Methods for applying the inventive mixtures and compositions thereof, respectively, on to plant propagation material, especially seeds include dressing, coating, pelleting, dusting, soaking and in-furrow application methods of the propagation material. Preferably, the inventive mixtures or the compositions thereof, respectively, are applied on to the plant propagation material by a method such that germination is not induced, e. g. by seed dressing, pelleting, coating and dusting.

The separate or joint application of the compounds of the inventive mixtures by spraying or dusting the seeds, the seedlings, the plants or the soils can be made before or after sowing of the plants or before or after emergence of the plants.

When employed in plant protection, the amounts of active substances applied are, depending on the kind of effect desired, from 0.001 to 2 kg per ha, preferably from 0.005 to 2 kg per ha, more preferably from 0.01 to 1.0 kg per ha, and in particular from 0.05 to 0.75 kg per ha.

In treatment of plant propagation materials such as seeds, e. g. by dusting, coating or drenching seed, amounts of active substance of from 0.01-10 kg, preferably from 0.1-1000 g, more preferably from 1-100 g per 100 kilogram of plant propagation material (preferably seeds) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual compounds of the inventive mixtures formulated as composition or partially premixed components, e. g. components set forth in the inventive mixtures may be mixed by the user in a spray tank and further auxiliaries and additives may be added, if appropriate (tank mix).

In a further embodiment, either individual components of the composition according to the invention or partially premixed components, e. g. components comprising the compound I and II (or the compounds inventive ternary and quarternary mixtures), can be applied jointly (e. g. after tankmix) or consecutively.

As said above, the present invention comprises a method for controlling pests, that means animal pests and/or harmful fungi, wherein the pest, their habitat, breeding grounds, their locus or the plants to be protected against pest attack, the soil or plant propagation material (preferably seed) are treated with an pesticidally effective amount of a mixture.

Advantageously, the inventive mixtures are suitable for controlling the following fungal plant diseases:

Albugo spp. (white rust) on ornamentals, vegetables (e. g. A. candida) and sunflowers (e. g. A. tragopogonis); Alternaria spp. (Alternaria leaf spot) on vegetables, rape (A. brassicola or brassicae), sugar beets (A. tenuis), fruits, rice, soybeans, potatoes (e. g. A. solani or A. alternate), tomatoes (e. g. A. solani or A. alternate) and wheat; Aphanomyces spp. on sugar beets and vegetables; Ascochyta spp. on cereals and vegetables, e. g. A. tritici (anthracnose) on wheat and A. hordei on barley; Bipolaris and Drechslera spp. (teleomorph: Cochliobolus spp.), e. g. Southern leaf blight (D. maydis) or Northern leaf blight (B. zeicola) on corn, e. g. spot blotch (B. sorokiniana) on cereals and e.g. B. oryzae on rice and turfs; Blumeria (formerly Erysiphe) graminis (powdery mildew) on cereals (e. g. on wheat or barley); Botrytis cinerea (teleomorph: Botryotinia fuckeliana: grey mold) on fruits and berries (e. g. strawberries), vegetables (e. g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e. g. C. ulmi (Dutch elm disease) on elms; Cercospora spp. (Cercospora leaf spots) on corn (e.g. Gray leaf spot: C. zeae-maydis), rice, sugar beets (e. g. C. beticola), sugar cane, vegetables, coffee, soybeans (e. g. C. sojina or C. kikuchil) and rice; Cladosporium spp. on tomatoes (e. g. C. fulvum: leaf mold) and cereals, e. g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e. g. C. sativus, anamorph: B. sorokiniana) and rice (e. g. C. miyabeanus, anamorph: H. oryzae); Colletotrichum (teleomorph: Glomerella) spp. (anthracnose) on cotton (e. g. C. gossypii), corn (e. g. C. graminicola: Anthracnose stalk rot), soft fruits, potatoes (e. g. C. coccodes: black dot), beans (e. g. C. lindemuthianum) and soybeans (e. g. C. truncatum or C. gloeosporioides); Corticium spp., e. g. C. sasakii (sheath blight) on rice; Corynespora cassiicola (leaf spots) on soybeans and ornamentals; Cycloconium spp., e. g. C. oleaginum on olive trees; Cylindrocarpon spp. (e. g. fruit tree canker or young vine decline, teleomorph: Nectria or Neonectria spp.) on fruit trees, vines (e. g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e. g. D. phaseolorum (damping off) on soybeans; Drechslera (syn. Helminthosporium, teleomorph: Pyrenophora) spp. on corn, cereals, such as barley (e. g. D. teres, net blotch) and wheat (e. g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e. g. E. pisi), such as cucurbits (e. g. E. cichoracearum), cabbages, rape (e. g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e. g. E. turcicum); Fusarium (teleomorph: Gibberella) spp. (wilt, root or stem rot) on various plants, such as F. graminearum or F. culmorum (root rot, scab or head blight) on cereals (e. g. wheat or barley), F. oxysporum on tomatoes, F. solani (f. sp. glycines now syn. F. virguliforme) and F. tucumaniae and F. brasiliense each causing sudden death syndrome on soybeans and F. verticillioides on corn; Gaeumannomyces graminis (take-all) on cereals (e. g. wheat or barley) and corn; Gibberella spp. on cereals (e. g. G. zeae) and rice (e. g. G. fujikuroi: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e. g. G. sabinae (rust) on pears; Helminthosporium spp. (syn. Drechslera, teleomorph: Cochliobolus) on corn, cereals and rice; Hemileia spp., e. g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e. g. wheat or barley); Microsphaera diffusa (powdery mildew) on soybeans; Monilinia spp., e. g. M. laxa, M. fructicola and M. fructigena (bloom and twig blight, brown rot) on stone fruits and other rosaceous plants; Mycosphaerella spp. on cereals, bananas, soft fruits and ground nuts, such as e. g. M. graminicola (anamorph: Septoria tritici, Septoria blotch) on wheat or M. fijiensis (black Sigatoka disease) on bananas; Peronospora spp. (downy mildew) on cabbage (e. g. P. brassicae), rape (e. g. P. parasitica), onions (e. g. P. destructor), tobacco (P. tabacina) and soybeans (e. g. P. manshurica); Phakopsora pachyrhizi and P. meibomiae (soybean rust) on soybeans; Phialophora spp. e. g. on vines (e. g. P. tracheiphila and P. tetraspora) and soybeans (e. g. P. gregata: stem rot); Phoma lingam (root and stem rot) on rape and cabbage and P. betae (root rot, leaf spot and damping-off) on sugar beets; Phomopsis spp. on sunflowers, vines (e. g. P. viticola: can and leaf spot) and soybeans (e. g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e. g. P. capsici), soybeans (e. g. P. megasperma, syn. P. sojae), potatoes and tomatoes (e. g. P. infestans: late blight) and broad-leaved trees (e. g. P. ramorum: sudden oak death); Plasmodiophora brassicae (club root) on cabbage, rape, radish and other plants; Plasmopara spp., e. g. P. viticola (grapevine downy mildew) on vines and P. halstedii on sunflowers; Podosphaera spp. (powdery mildew) on rosaceous plants, hop, pome and soft fruits, e. g. P. leucotricha on apples; Polymyxa spp., e. g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e. g. wheat or barley; Pseudoperonospora (downy mildew) on various plants, e. g. P. cubensis on cucurbits or P. humili on hop; Pseudopezicula tracheiphila (red fire disease or ‘rotbrenner’, anamorph: Phialophora) on vines; Puccinia spp. (rusts) on various plants, e. g. P. triticina (brown or leaf rust), P. striiformis (stripe or yellow rust), P. hordei (dwarf rust), P. graminis (stem or black rust) or P. recondita (brown or leaf rust) on cereals, such as e. g. wheat, barley or rye, P. kuehnii (orange rust) on sugar cane and P. asparagi on asparagus; Pyrenophora (anamorph: Drechslera) tritici-repentis (tan spot) on wheat or P. teres (net blotch) on barley; Pyricularia spp., e. g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e. g. P. ultimum or P. aphanidermatum); Ramularia spp., e. g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e. g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e. g. S. sclerotiorum) and soybeans (e. g. S. rolfsii or S. sclerotiorum); Septoria spp. on various plants, e. g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e. g. S. turcicum, syn. Helminthosporium turcicum) and turf; Sphacelotheca spp. (smut) on corn, (e. g. S. reiliana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e. g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e. g. T. deformans (leaf curl disease) on peaches and T. pruni (plum pocket) on plums; Thielaviopsis spp. (black root rot) on tobacco, pome fruits, vegetables, soybeans and cotton, e. g. T. basicola (syn. Chalara elegans); Tilletia spp. (common bunt or stinking smut) on cereals, such as e. g. T. tritici (syn. T. caries, wheat bunt) and T. controversa (dwarf bunt) on wheat; Typhula incarnata (grey snow mold) on barley or wheat; Urocystis spp., e. g. U. occulta (stem smut) on rye; Uromyces spp. (rust) on vegetables, such as beans (e. g. U. appendiculatus, syn. U. phaseoli) and sugar beets (e. g. U. betae); Ustilago spp. (loose smut) on cereals (e. g. U. nuda and U. avaenae), corn (e. g. U. maydis: corn smut) and sugar cane; Venturia spp. (scab) on apples (e. g. V. inaequalis) and pears; and Verticillium spp. (wilt) on various plants, such as fruits and ornamentals, vines, soft fruits, vegetables and field crops, e. g. V. dahliae on strawberries, rape, potatoes and tomatoes.

The mixtures according to the present invention and compositions thereof, respectively, are also suitable for controlling harmful fungi in the protection of stored products or harvest and in the protection of materials. The term “protection of materials” is to be understood to denote the protection of technical and non-living materials, such as adhesives, glues, wood, paper and paperboard, textiles, leather, paint dispersions, plastics, coiling lubricants, fiber or fabrics, against the infestation and destruction by harmful microorganisms, such as fungi and bacteria. As to the protection of wood and other materials, the particular attention is paid to the following harmful fungi: Ascomycetes such as Ophiostoma spp., Ceratocystis spp., Aureobasidium pullulans, Sclerophoma spp., Chaetomium spp., Humicola spp., Petriella spp., Trichurus spp.; Basidiomycetes such as Coniophora spp., Coriolus spp., Gloeophyllum spp., Lentinus spp., Pleurotus spp., Poria spp., Serpula spp. and Tyromyces spp., Deuteromycetes such as Aspergillus spp., Cladosporium spp., Penicillium spp., Trichorma spp., Alternaria spp., Paecilomyces spp. and Zygomycetes such as Mucor spp., and in addition in the protection of stored products and harvest the following yeast fungi are worthy of note: Candida spp. and Saccharomyces cerevisae.

They are particularly important for controlling a multitude of fungi on various cultivated plants, such as bananas, cotton, vegetable species (for example cucumbers, beans and cucurbits), cereals such as wheat, rye, barley, rice, oats; grass coffee, potatoes, corn, fruit species, soya, tomatoes, grapevines, ornamental plants, sugar cane and also on a large number of seeds. In a preferred embodiment, the inventive mixtures are used in soya (soybean), cereals and corn.

The inventive mixtures (except the binary mixture) exhibit also outstanding action against animal pests from the following orders:

insects from the order of the lepidopterans (Lepidoptera), for example Agrotis ipsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,
beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicomis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria, flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inomata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophi-lus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscina stabulans, Oestrus ovis, Opomyza forum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa
thrips (Thysanoptera), e.g. Dichromothrips corbetti, Dichromothrips ssp, Frankliniella fusca, Frankliniella occidentalis, Frankliniella tritici, Scirtothrips citri, Thrips oryzae, Thrips palmi and Thrips tabaci,
termites (Isoptera), e.g. Calotermes flavicollis, Leucotermes flavipes, Heterotermes aureus, Reticulitermes flavipes, Reticulitermes virginicus, Reticulitermes lucifugus, Termes natalensis, and Coptotermes formosanus,
cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,
true bugs (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius senilis, Triatoma spp., and Arilus critatus.
ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex califonnicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,
crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca Americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina,
Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Omithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa, fleas (Siphonaptera), e.g. Ctenocephalides fells, Ctenocephalides canis, Xenopsylla cheopis, Pulex irritans, Tunga penetrans, and Nosopsyllus fasciatus,
silverfish, firebrat (Thysanura), e.g. Lepisma saccharina and Thermobia domestica,
centipedes (Chilopoda), e.g. Scutigera coleoptrata,
millipedes (Diplopoda), e.g. Narceus spp.,
Earwigs (Dermaptera), e.g. forficula auricularia,
lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus,
plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchoides ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Hellcotylenchus species, Rotylenchus robustus and other Rotylenchus species; sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species; burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species.

The mixtures according to the invention can be applied to any and all developmental stages of pests, such as egg, larva, pupa, and adult. The pests may be controlled by contacting the target pest, its food supply, habitat, breeding ground or its locus with a pesticidally effective amount of the inventive mixtures or of compositions comprising the mixtures.

“Locus” means a plant, plant propagation material (preferably seed), soil, area, material or environment in which a pest is growing or may grow.

When preparing the mixtures, it is preferred to employ the pure active compounds, to which further active compounds against pests, such as insecticides, herbicides, fungicides or else herbicidal or growth-regulating active compounds or fertilizers can be added as further active components according to need.

The inventive mixtures are employed by treating the fungi or the plants, plant propagation materials (preferably seeds), materials or soil to be protected from fungal attack with a pesticidally effective amount of the active compounds. The application can be carried out both before and after the infection of the materials, plants or plant propagation materials (preferably seeds) by the pests.

In the context of the present invention, the term plant refers to an entire plant, a part of the plant or the propagation material of the plant.

The term “plant” denotes various cultivated plants, such as cereals, e. g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevia); natural rubber plants or ornamental and forestry plants, such as flowers, shrubs, broad-leaved trees or evergreens, e. g. conifers; and on the plant propagation material, such as seeds, and the crop material of these plants.

Preferred plants are field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

Preferably, treatment of plant propagation materials with the inventive mixtures and compositions thereof, respectively, is used for plants cereals, such as wheat, rye, barley and oats; potatoes, tomatoes, vines, rice, corn, cotton and soybeans.

The term “plants” is also to be understood as including plants which have been modified by breeding, mutagenesis or genetic engineering including but not limiting to agricultural biotech products on the market or in development (cf. http://cera-gmc.org/, see GM crop database therein). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or farnesylated moieties or PEG moieties.

Plants that have been modified by breeding, mutagenesis or genetic engineering, e. g. have been rendered tolerant to applications of specific classes of herbicides, such as auxin herbicides such as dicamba or 2,4-D; bleacher herbicides such as hydroxylphenylpyruvate dioxygenase (HPPD) inhibitors or phytoene desaturase (PDS) inhibitors; acetolactate synthase (ALS) inhibitors such as sulfonyl ureas or imidazolinones; enolpyruvylshikimate-3-phosphate synthase (EPSPS) inhibitors, such as glyphosate; glutamine synthetase (GS) inhibitors such as glufosinate; protoporphyrinogen-IX oxidase inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are e. g. described in Pest Managem. Sci. 61, 2005, 246; 61, 2005, 258; 61, 2005, 277; 61, 2005, 269; 61, 2005, 286; 64, 2008, 326; 64, 2008, 332; Weed Sci. 57, 2009, 108; Austral. J. Agricult. Res. 58, 2007, 708; Science 316, 2007, 1185; and references quoted therein. Several cultivated plants have been rendered tolerant to herbicides by conventional methods of breeding (mutagenesis), e. g. Clearfield® summer rape (Canola, BASF SE, Germany) being tolerant to imidazolinones, e. g. imazamox, or ExpressSun® sunflowers (DuPont, USA) being tolerant to sulfonyl ureas, e. g. tribenuron. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.), Cultivance® (imidazolinone tolerant, BASF SE, Germany) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are disclosed, e. g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e. g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e. g. EP-A 392 225), plant disease resistance genes (e. g. potato cultivars, which express resistance genes acting against Phytophthora infestans derived from the mexican wild potato Solanum bulbocastanum) or T4-lysozym (e. g. potato cultivars capable of synthesizing these proteins with increased resistance against bacteria such as Erwinia amylvora). The methods for producing such genetically modified plants are generally known to the person skilled in the art and are described, e. g. in the publications mentioned above.

Furthermore, plants are also covered that are by the use of recombinant DNA techniques capable to synthesize one or more proteins to increase the productivity (e. g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e. g. oil crops that produce health-promoting long-chain omega-3 fatty acids or unsaturated omega-9 fatty acids (e. g. Nexera® rape, DOW Agro Sciences, Canada).

Furthermore, plants are also covered that contain by the use of recombinant DNA techniques a modified amount of substances of content or new substances of content, specifically to improve raw material production, e. g. potatoes that produce increased amounts of amylopectin (e. g. Amflora® potato, BASF SE, Germany).

According to another embodiment, the present invention relates to synergistic mixtures comprising as active components,
1) one fungicidal compound IA selected from the group consisting of
   A) Respiration inhibitors
      Inhibitors of complex III at Qo site: azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, fenamidone;
      inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate; (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate
      inhibitors of complex II (e. g. carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide;
      other respiration inhibitors (e.g. complex I, uncouplers): diflumetorim, (5,8-difluoroquinazolin-4-yl)-{2-[2-fluoro-4-(4-trifluoromethylpyridin-2-yloxy)-phenyl]-ethyl}-amine; nitrophenyl derivates: binapacryl, dinobuton, dinocap, fluazinam; ferimzone; organometal compounds: fentin salts, such as fentin-acetate, fentin chloride or fentin hydroxide; ametoctradin; and silthiofam;
   B) Sterol biosynthesis inhibitors (SBI fungicides)
      C14 demethylase inhibitors (DMI fungicides): triazoles: azaconazole, bitertanol, bromuconazole, cyproconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-[rel-(2S; 3R)-3-(2-chlorophenyl)-2-(2,4-difluorophenyl)-oxiranylmethyl]-5-thio-cyanato-1H-[1,2,4]triazole, 2-[rel-(2S; 3R)-3-(2-chlorophenyl)-2-(2,4-difluorophenyl)-oxiranylmethyl]-2H-[1,2,4]triazole-3-thiol; imidazoles: imazalil, pefurazoate, prochloraz, triflumizol; pyrimidines, pyridines and piperazines: fenarimol, nuarimol, pyrifenox, triforine;
      Delta14-reductase inhibitors: aldimorph, dodemorph, dodemorph-acetate, fenpropimorph, tridemorph, fenpropidin, piperalin, spiroxamine;
      Inhibitors of 3-keto reductase: fenhexamid;
   C) Nucleic acid synthesis inhibitors
      phenylamides or acyl amino acid fungicides: benalaxyl, benalaxyl-M, kiralaxyl, metalaxyl, ofurace, oxadixyl;
      others: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxyl)pyrimidin-4-amine;
   D) Inhibitors of cell division and cytoskeleton
      tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine
      other cell division inhibitors: diethofencarb, ethaboxam, pencycuron, fluopicolide, zoxamide, metrafenone, pyriofenone;
   E) Inhibitors of amino acid and protein synthesis
      methionine synthesis inhibitors (anilino-pyrimidines): cyprodinil, mepanipyrim, pyrimethanil;
      protein synthesis inhibitors: blasticidin-S, kasugamycin, kasugamycin hydrochloride-hydrate, mildiomycin, streptomycin, oxytetracyclin, polyoxine, validamycin A;
   F) Signal transduction inhibitors
      MAP/histidine kinase inhibitors: fluoroimid, iprodione, procymidone, vinclozolin, fenpiclonil;
      G protein inhibitors: quinoxyfen;
   G) Lipid and membrane synthesis inhibitors
      Phospholipid biosynthesis inhibitors: edifenphos, iprobenfos, pyrazophos, isoprothiolane;
      lipid peroxidation: dicloran, quintozene, tecnazene, tolclofos-methyl, biphenyl, chloroneb, etridiazole;
      phospholipid biosynthesis and cell wall deposition: dimethomorph, flumorph, mandipropamid, pyrimorph, benthiavalicarb, iprovalicarb, valifenalate and N-(1-(1-(4-cyano-phenyl)ethanesulfonyl)-but-2-yl) carbamic acid-(4-fluorophenyl) ester;
      compounds affecting cell membrane permeability and fatty acids: propamocarb, propamocarb-hydrochlorid
      fatty acid amide hydrolase inhibitors: 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone
   H) Inhibitors with Multi Site Action
      inorganic active substances: Bordeaux mixture, copper acetate, copper hydroxide, copper oxychloride, basic copper sulfate, sulfur;
      thio- and dithiocarbamates: ferbam, mancozeb, maneb, metam, metiram, propineb, thiram, zineb, ziram;
      organochlorine compounds (e.g. phthalimides, sulfamides, chloronitriles): anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;
      guanidines and others: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithiino[2,3-c:5,6-c′]dipyrrole-1,3,5,7(2H,6H)-tetraone;
   I) Cell wall synthesis inhibitors
      inhibitors of glucan synthesis: validamycin, polyoxin B; melanin synthesis inhibitors: pyroquilon, tricyclazole, carpropamid, dicyclomet, fenoxanil;
   J) Plant defence inducers
      acibenzolar-S-methyl, probenazole, isotianil, tiadinil, prohexadione-calcium; phosphonates: fosetyl, fosetyl-aluminum, phosphorous acid and its salts; and
   K) Unknown mode of action comprising the compounds bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxine-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2methoxy-acetic acid 6-tert-butyl-8-fluoro-2,3-dimethyl-quinolin-4-yl ester, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl)cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide;
   or
2) one insecticidal compound IB selected from the group consisting of:
   M-1.A acetylcholine esterase inhibitors from the class of carbamates,
   for example aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, and triazamate;
   M-1.B acetylcholine esterase inhibitors from the class of organophosphates,
   for example acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion,
   mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;
   M-2 GABA-gated chloride channel antagonists comprising the subgroups
   M-2.A cyclodiene organochlorine compounds,
   for example endosulfan; or
   M-2.B fiproles (phenylpyrazoles),
   for example ethiprole, fipronil, flufiprole, pyrafluprole, or pyriprole;
   M-2. Others, for example 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide or the compound 4-[5-(3,5-dichlorophenyl)-5-(trifluoromethyl)-4H-isoxazol-3-yl]-2-methyl-N-[2-oxo-2-(2,2,2-trifluoroethylamino)ethyl]benzamide;
   M-3 sodium channel modulators from the class of pyrethroids, for example acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, permethrin, phenothrin, prallethrin, profluthrin, pyrethrin (pyrethrum), resmethrin, silafluofen, tefluthrin, tetramethylfluthrin, tetramethrin, tralomethrin, transfluthrin, DDT and methoxychlor;
   M-4 nicotinic acteylcholine receptor agonists from the class of neonicotinoids; for example acteamiprid, chlothianidin, cycloxaprid, dinotefuran, flupyradifurone, imidacloprid, nitenpyram, sulfoxaflor, thiacloprid, thiamethoxam or the compound 1-[(6-chloro-3-pyridyl)methyl]-7-methyl-8-nitro-5-propoxy-3,5,6,7-tetrahydro-2H-imidazo[1,2-a]pyridine (known from WO 2007/101369);
   M-5 allosteric nicotinic acteylcholine receptor activators from the class of spinosyns, for example spinosad, spinetoram;
   M-6 chloride channel activators from the class of mectins, for example abamectin, emamectin benzoate, ivermectin, lepimectin or milbemectin;
   M-7 juvenile hormone mimics, for example hydroprene, kinoprene, methoprene, fenoxycarb or pyriproxyfen;
   M-8 non-specific multi-site inhibitors, for example methyl bromide and other alkyl halides, chloropicrin, sulfuryl fluoride, borax or tartar emetic;
   M-9 selective homopteran feeding blockers, for example pymetrozine, flonicamid or pyrifluquinazon;
   M-10 mite growth inhibitors, for example clofentezine, hexythiazox, diflovidazin or etoxazole;
   M-11 microbial disruptors of insect midgut membranes, for example bacillus thuringiensis subsp. israelensis, bacillus sphaericus, bacillus thuringiensis subsp. aizawai, bacillus thuringiensis subsp. kurstaki, bacillus thuringiensis subsp. tenebrionis, or Bt crop proteins: Cry1Ab, Cry1Ac, Cry1Fa, Cry2Ab, mCry3A, Cry3Ab,
   Cry3Bb, or Cry34/35Ab1;
   M-12 inhibitors of mitochondrial ATP synthase, for example diafenthiuron, azocyclotin, cyhexatin, fenbutatin oxide, propargite, or tetradifon;
   M-13 uncouplers of oxidative phosphorylation, for example chlorfenapyr, DNOC, or sulfluramid;
   M-14 nicotinic acetylcholine receptor channel blockers, for example bensultap, cartap hydrochloride, thiocyclam, thiosultap sodium;
   M-15 inhibitors of the chitin biosynthesis type 0 (benzoylurea class), for example bistrifluron, chlorfluazuron, diflubenzuron, flucycloxuron, flufenoxuron, hexaflumuron, lufenuron, novaluron, noviflumuron, teflubenzuron, triflumuron;
   M-16 inhibitors of the chitin biosynthesis type 1, for example buprofezin;
   M-17 moulting disruptors, for example cyromazine;
   M-18 Ecdyson receptor agonists,
   for example methoxyfenozide, tebufenozide, halofenozide, fufenozide or chromafenozide;
   M-19 Octopamin receptor agonists,
   for example amitraz;
   M-20 Mitochondrial complex III electron transport inhibitors,
   For example hydramethylnon, acequinocyl, flometoquin, fluacrypyrim or pyriminostrobin;
   M-21 Mitochondrial complex I electron transport inhibitors,
   for example: fenazaquin, fenpyroximate, pyrimidifen, pyridaben, tebufenpyrad, tolfenpyrad, flufenerim, or rotenone;
   M-22 Voltage-dependent sodium channel blockers,
   for example indoxacarb or metaflumizone;
   M-23 Inhibitors of the lipid synthesis, inhibitors of acetyl CoA carboxylase,
   for example spirodiclofen, spiromesifen or spirotetramat;
   M-25 Mitochondrial complex II electron transport inhibitors,
   for example cyenopyrafen, cyflumetofen or pyflubumide;
   M-28 Ryanodine receptor-modulators from the class of diamides,
   for example flubendiamide, chloranthraniliprole (rynaxypyr), cyanthraniliprole (cyazypyr),
   the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid or (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (both known from WO 2007/101540), the compound 3-bromo-N-{2-bromo-4-chloro-6-[(1-cyclopropylethyl)carbamoyl]phenyl}-1-(3-chlorpyridin-2-yl)-1H-pyrazole-5-carboxamide (known from WO 2005/077934), the compound methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate (known from WO 2007/043677), N2-[2-(3-chloro-2-pyridyl)-5-[(5-methyltetrazol-2-yl)methyl]pyrazol-3-yl]-5-cyano-N1,3-dimethyl-phthalamide; and
   M-29 Others, for example 2-(5-ethylsulfinyl-2-fluoro-4-methyl-phenyl)-5-methyl-1,2,4-triazol-3-amine (known from WO 06/043635), 1-(5-ethylsulfinyl-2,4-dimethyl-phenyl)-3-methyl-1,2,4-triazole, bacillus firmus strain “CNCM I-1582”; or
3) one antifungal biocontrol agents and plant bioactivators IC selected from the group consisting of Ampelomyces quisqualis (e.g. AQ 10® from Intrachem Bio GmbH & Co. KG, Germany), Aspergillus flavus (e.g. AFLAGUARD® from Syngenta, CH), Aureobasidium pullulans (e.g. BOTECTOR® from bio-ferm GmbH, Germany), Bacillus pumilus (e.g. NRRL Accession No. B-30087 in SONATA® and BALLAD® Plus from AgraQuest Inc., USA), Bacillus subtilis (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (e.g. TAEGRO® from Novozyme Biologicals, Inc., USA), Candida oleophila I-82 (e.g. ASPIRE® from Ecogen Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446: PRESTOP® from Verdera, Finland), Coniothyrium minitans (e.g. CONTANS® from Prophyta, Germany), Cryphonectria parasitica (e.g. Endothia parasitica from CNICM, France), Cryptococcus albidus (e.g. YIELD PLUS® from Anchor Bio-Technologies, South Africa), Fusarium oxysporum (e.g. BIOFOX® from S.I.A.P.A., Italy, FUSACLEAN® from Natural Plant Protection, France), Metschnikowia fructicola (e.g. SHEMER® from Agrogreen, Israel), Microdochium dimerum (e.g. ANTI BOT® from Agrauxine, France), Phlebiopsis gigantea (e.g. ROTSOP® from Verdera, Finland), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis (e.g. REGALIA® from Marrone BioInnovations, USA), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. harzianum T-22 (e.g. PLANT-SHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., India, BIO-CURE® F from T. Stanes & Co. Ltd., India), T. viride TV1 (e.g. T. viride TV1 from Agribiotec srl, Italy), Ulocladium oudemansii HRU3 (e.g. BOTRY-ZEN® from Botry-Zen Ltd, NZ); and
4) one compound II selected from jasmonic acid, salts or derivatives thereof.

1-21. (canceled)

22. A synergistic mixture comprising, as active components,
1) one fungicidal compound IA selected from the group consisting of
A) Respiration inhibitors
Inhibitors of complex III at Qₒ site (e.g. strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, mandestrobine, metominostrobin, orysastrobin, picoxystrobin, pyraclostrobin, pyrametostrobin, pyraoxystrobin, trifloxystrobin and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, fenamidone;
inhibitors of complex III at Qᵢ site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate; (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate
inhibitors of complex II (e. g. carboxamides): benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)-pyrazole-4-carboxamide, 1,3,5-trimethyl-N-(1,1,3-trimethylindan-4-yl)pyrazole-4-carboxamide, N-(7-fluoro-1,1,3-trimethyl-indan-4-yl)-1,3-dimethyl-pyrazole-4-carboxamide, N-[2-(2,4-dichlorophenyl)-2-methoxy-1-methyl-ethyl]-3-(difluoromethyl)-1-methyl-pyrazole-4-carboxamide;
other respiration inhibitors (e.g. complex I, uncouplers): diflumetorim, (5,8-difluoroquinazolin-4-yl)-{2-[2-fluoro-4-(4-trifluoromethylpyridin-2-yloxy)-phenyl]-ethyl}-amine; nitrophenyl derivates: binapacryl, dinobuton, dinocap, fluazinam; ferimzone; organometal compounds: fentin salts, such as fentin-acetate, fentin chloride or fentin hydroxide; ametoctradin; and silthiofam;
B) Sterol biosynthesis inhibitors (SBI fungicides)
C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-[rel-(2S; 3R)-3-(2-chlorophenyl)-2-(2,4-difluorophenyl)-oxiranylmethyl]-5-thio-cyanato-1H-[1,2,4]triazole, 2-[rel-(2S; 3R)-3-(2-chlorophenyl)-2-(2,4-difluorophenyl)-oxiranylmethyl]-2H-[1,2,4]triazole-3-thiol, 2-[2-chloro-4-(4-chlorophenoxyl)phenyl]-1-(1,2,4-triazol-1-yl)pentan-2-ol, 1-[4-(4-chlorophenoxy)-2-(trifluoromethyl)phenyl]-1-cyclopropyl-2-(1,2,4-triazol-1-yl)ethanol, 2-[4-(4-chlorophenoxy)-2-(trifluoromethyl)phenyl]-1-(1,2,4-triazol-1-yl)butan-2-ol, 2-[2-chloro-4-(4-chlorophenoxyl)phenyl]-1-(1,2,4-triazol-1-yl)butan-2-ol, 2-[4-(4-chlorophenoxy)-2-(trifluoromethyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)propan-2-ol, 2-[2-chloro-4-(4-chlorophenoxyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)pentan-2-ol, 2-[4-(4-fluorophenoxy)-2-(trifluoromethyl)phenyl]-1-(1,2,4-triazol-1-yl)propan-2-ol; imidazoles: imazalil, pefurazoate, prochloraz, triflumizol; pyrimidines, pyridines and piperazines: fenarimol, nuarimol, pyrifenox, triforine, [3-(4-chloro-2-fluoro-phenyl)-5-(2,4-difluorophenyl)isoxazol-4-yl]-(3-pyridyl)methanol;
Delta14-reductase inhibitors: aldimorph, dodemorph, dodemorph-acetate, fenpropimorph, tridemorph, fenpropidin, piperalin, spiroxamine;
Inhibitors of 3-keto reductase: fenhexamid;
C) Nucleic acid synthesis inhibitors
phenylamides or acyl amino acid fungicides: benalaxyl, benalaxyl-M, kiralaxyl, metalaxyl, metalaxyl-M (mefenoxam), ofurace, oxadixyl;
others: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxy)pyrimidin-4-amine;
D) Inhibitors of cell division and cytoskeleton
tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine
other cell division inhibitors: diethofencarb, ethaboxam, pencycuron, fluopicolide, zoxamide, metrafenone, pyriofenone;
E) Inhibitors of amino acid and protein synthesis
methionine synthesis inhibitors (anilino-pyrimidines): cyprodinil, mepanipyrim, pyrimethanil;
protein synthesis inhibitors: blasticidin-S, kasugamycin, kasugamycin hydrochloride-hydrate, mildiomycin, streptomycin, oxytetracyclin, polyoxine, validamycin A;
F) Signal transduction inhibitors
MAP/histidine kinase inhibitors: fluoroimid, iprodione, procymidone, vinclozolin, fenpiclonil, fludioxonil;
G protein inhibitors: quinoxyfen;
G) Lipid and membrane synthesis inhibitors
Phospholipid biosynthesis inhibitors: edifenphos, iprobenfos, pyrazophos, isoprothiolane;
lipid peroxidation: dicloran, quintozene, tecnazene, tolclofos-methyl, biphenyl, chloroneb, etridiazole;
phospholipid biosynthesis and cell wall deposition: dimethomorph, flumorph, mandipropamid, pyrimorph, benthiavalicarb, iprovalicarb, valifenalate and N-(1-(1-(4-cyano-phenyl)ethanesulfonyl)-but-2-yl) carbamic acid-(4-fluorophenyl) ester;
compounds affecting cell membrane permeability and fatty acids: propamocarb, propamocarb-hydrochlorid
fatty acid amide hydrolase inhibitors: oxathiapiprolin;
H) Inhibitors with Multi Site Action
inorganic active substances: Bordeaux mixture, copper acetate, copper hydroxide, copper oxychloride, basic copper sulfate, sulfur;
thio- and dithiocarbamates: ferbam, mancozeb, maneb, metam, metiram, propineb, thiram, zineb, ziram;
organochlorine compounds (e.g. phthalimides, sulfamides, chloronitriles): anilazine, chlorothalonil, captafol, captan, folpet, dichlofluanid, dichlorophen, hexachlorobenzene, pentachlorphenole and its salts, phthalide, tolylfluanid, N-(4-chloro-2-nitro-phenyl)-N-ethyl-4-methyl-benzenesulfonamide;
guanidines and others: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithiino[2,3-c:5,6-c′]dipyrrole-1,3,5,7(2H,6H)-tetraone;
I) Cell wall synthesis inhibitors
inhibitors of glucan synthesis: validamycin, polyoxin B; melanin synthesis inhibitors: pyroquilon, tricyclazole, carpropamid, dicyclomet, fenoxanil;
J) Plant defence inducers
acibenzolar-S-methyl, probenazole, isotianil, tiadinil, prohexadione-calcium;
phosphonates: fosetyl, fosetyl-aluminum, phosphorous acid and its salts;
K) Unknown mode of action
bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, picarbutrazox, tolprocarb, 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, methoxy-acetic acid 6-tert-butyl-8-fluoro-2,3-dimethyl-quinolin-4-yl ester, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl)cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide, ethyl (Z)-3-amino-2-cyano-3-phenyl-prop-2-enoate, pentyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(8-fluoro-2-methyl-3-quinolyl)oxy]phenyl]propan-2-ol, 3-(5-fluoro-3,3,4,4-tetramethyl-3,4-dihydroisoquinolin-1-yl)quinoline, 3-(4,4-difluoro-3,3-dimethyl-3,4-dihydroisoquinolin-1-yl)quinoline, 3-(4,4,5-trifluoro-3,3-dimethyl-3,4-dihydroisoquinolin-1-yl)quinoline;
or
2) one insecticidal compound IB selected from the group consisting of
M.1 Acetylcholine esterase (AChE) inhibitors from the class of
M.1A carbamates, for example aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of
M.1B organophosphates, for example acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;
M.2. GABA-gated chloride channel antagonists such as:
M.2A cyclodiene organochlorine compounds, as for example endosulfan or chlordane; or
M.2B fiproles (phenylpyrazoles), as for example ethiprole, fipronil, flufiprole, pyrafluprole and pyriprole;
M.3 Sodium channel modulators from the class of
M.3A pyrethroids, for example acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or
M.3B sodium channel modulators such as DDT or methoxychlor;
M.4 Nicotinic acetylcholine receptor agonists (nAChR) from the class of
M.4A neonicotinoids, for example acteamiprid, chlothianidin, dinotefuran, imidacloprid, nitenpyram, thiacloprid and thiamethoxam; or the compounds
M.4A.1: 1-[(6-chloro-3-pyridinyl)methyl]-2,3,5,6,7,8-hexahydro-9-nitro-(5S,8R)-5,8-Epoxy-1H-imidazo[1,2-a]azepine; or
M.4A.2: 1-[(6-chloro-3-pyridyl)methyl]-2-nitro-1-[(E)-pentylideneamino]guanidine; or
M4.A.3: 1-[(6-chloro-3-pyridyl)methyl]-7-methyl-8-nitro-5-propoxy-3,5,6,7-tetrahydro-2H-imidazo[1,2-a]pyridine;
or M.4B nicotine.
M.5 Nicotinic acetylcholine receptor allosteric activators from the class of spinosyns, for example spinosad or spinetoram;
M.6 Chloride channel activators from the class of avermectins and milbemycins, for example abamectin, emamectin benzoate, ivermectin, lepimectin or milbemectin;
M.7 Juvenile hormone mimics, such as
M.7A juvenile hormone analogues as hydroprene, kinoprene and methoprene; or others as M.7B fenoxycarb or M.7C pyriproxyfen;
M.8 miscellaneous non-specific (multi-site) inhibitors, for example
M.8A alkyl halides as methyl bromide and other alkyl halides, or
M.8B chloropicrin, or M.8C sulfuryl fluoride, or M.8D borax, or M.8E tartar emetic;
M.9 Selective homopteran feeding blockers, for example
M.9B pymetrozine, or M.9C flonicamid;
M.10 Mite growth inhibitors, for example
M.10A clofentezine, hexythiazox and diflovidazin, or M.10B etoxazole;
M.11 Microbial disruptors of insect midgut membranes, for example bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;
M.12 Inhibitors of mitochondrial ATP synthase, for example
M.12A diafenthiuron, or
M.12B organotin miticides such as azocyclotin, cyhexatin or fenbutatin oxide, or
M.12C propargite, or M.12D tetradifon;
M.13 Uncouplers of oxidative phosphorylation via disruption of the proton gradient, for example chlorfenapyr, DNOC or sulfluramid;
M.14 Nicotinic acetylcholine receptor (nAChR) channel blockers, for example nereistoxin analogues as bensultap, cartap hydrochloride, thiocyclam or thiosultap sodium;
M.15 Inhibitors of the chitin biosynthesis type 0, such as benzoylureas as for example bistrifluron, chlorfluazuron, diflubenzuron, flucycloxuron, flufenoxuron, hexaflumuron, lufenuron, novaluron, noviflumuron, teflubenzuron or triflumuron;
M.16 Inhibitors of the chitin biosynthesis type 1, as for example buprofezin;
M.17 Moulting disruptors, Dipteran, as for example cyromazine;
M.18 Ecdyson receptor agonists such as diacylhydrazines, for example methoxyfenozide, tebufenozide, halofenozide, fufenozide or chromafenozide;
M.19 Octopamin receptor agonists, as for example amitraz;
M.20 Mitochondrial complex III electron transport inhibitors, for example
M.20A hydramethylnon, or M.20B acequinocyl, or M.20C fluacrypyrim;
M.21 Mitochondrial complex I electron transport inhibitors, for example
M.21A METI acaricides and insecticides such as fenazaquin, fenpyroximate, pyrimidifen, pyridaben, tebufenpyrad or tolfenpyrad, or M.21B rotenone;
M.22 Voltage-dependent sodium channel blockers, for example
M.22A indoxacarb, or M.22B metaflumizone, or M.22C 1-[(E)-[2-(4-cyanophenyl)-1-[3-(trifluoromethyl)phenyl]ethylidene]amino]-3-[4-(difluoromethoxy)phenyl]urea;
M.23 Inhibitors of the of acetyl CoA carboxylase, such as Tetronic and Tetramic acid derivatives, for example spirodiclofen, spiromesifen or spirotetramat;
M.24 Mitochondrial complex IV electron transport inhibitors, for example
M.24A phosphine such as aluminium phosphide, calcium phosphide, phosphine or zinc phosphide, or M.24B cyanide.
M.25 Mitochondrial complex II electron transport inhibitors, such as beta-ketonitrile derivatives, for example cyenopyrafen or cyflumetofen;
M.28 Ryanodine receptor-modulators from the class of diamides, as for example flubendiamide, chlorantraniliprole (Rynaxypyr®), cyantraniliprole (Cyazypyr®), or the phthalamide compounds
M.28.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and
M.28.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, or the compound
M.28.3: 3-bromo-N-{2-bromo-4-chloro-6-[(1-cyclopropylethyl)carbamoyl]phenyl}-1-(3-chlorpyridin-2-yl)-1H-pyrazole-5-carboxamide (proposed ISO name: cyclaniliprole), or the compound
M.28.4: methyl-2-({[3,5-dibromo-2-(1-[3-bromo-1-(3-chlorpyridin-2-yl)-1H-pyrazol-5-yl]carbonyl}amino)benzoyl]-1,2-dimethylhydrazinecarboxylate; or a compound selected from M.28.5a) to M.28.5l):
M.28.5a) N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide;
M.28.5b) N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide;
M.28.5c) N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide;
M.28.5d) N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide;
M.28.5e) N-[4,6-dichloro-2-[(diethyl-lambda-4-sulfanylidene)carbamoyl]-phenyl]-2-(3-chloro-2-pyridyl)-5-(difluoromethyl)pyrazole-3-carboxamide;
M.28.5 f) N-[4,6-dibromo-2-[(di-2-propyl-lambda-4-sulfanylidene)carbamoyl]-phenyl]-2-(3-chloro-2-pyridyl)-5-(trifluoromethyl)pyrazole-3-carboxamide;
M.28.5g) N-[4-chloro-2-[(di-2-propyl-lambda-4-sulfanylidene)carbamoyl]-6-cyano-phenyl]-2-(3-chloro-2-pyridyl)-5-(trifluoromethyl)pyrazole-3-carboxamide;
M.28.5h) N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide;
M.28.5i) N-[2-(5-amino-1,3,4-thiadiazol-2-yl)-4-chloro-6-methyl-phenyl]-5-bromo-2-(3-chloro-2-pyridyl)pyrazole-3-carboxamide;
M.28.5j) 5-chloro-2-(3-chloro-2-pyridyl)-N-[2,4-dichloro-6-[(1-cyano-1-methyl-ethyl)carbamoyl]phenyl]pyrazole-3-carboxamide;
M.28.5k) 5-bromo-N-[2,4-dichloro-6-(methylcarbamoyl)phenyl]-2-(3,5-dichloro-2-pyridyl)pyrazole-3-carboxamide;
M.28.5l) N-[2-(tert-butylcarbamoyl)-4-chloro-6-methyl-phenyl]-2-(3-chloro-2-pyridyl)-5-(fluoromethoxy)pyrazole-3-carboxamide; or a compound selected from
M.28.6 N2-(1-cyano-1-methyl-ethyl)-N1-(2,4-dimethylphenyl)-3-iodo-phthalamide; or
M.28.7 3-chloro-N2-(1-cyano-1-methyl-ethyl)-N1-(2,4-dimethylphenyl)phthalamide;
M.UN.X insecticidal active compounds of unknown or uncertain mode of action, as for example afidopyropen, azadirachtin, amidoflumet, benzoximate, bifenazate, bromopropylate, chinomethionat, cryolite, dicofol, flufenerim, flometoquin, fluensulfone, flupyradifurone, piperonyl butoxide, pyridalyl, pyrifluquinazon, sulfoxaflor, pyflubumide or the compounds
M.UN.X.1: 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound
M.UN.X.2: 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or the compound
M.UN.X.3: 11-(4-chloro-2,6-dimethylphenyl)-12-hydroxy-1,4-dioxa-9-azadispiro[4.2.4.2]-tetradec-11-en-10-one, or the compound
M.UN.X.4: 3-(4′-fluoro-2,4-dimethylbiphenyl-3-yl)-4-hydroxy-8-oxa-1-azaspiro[4.5]dec-3-en-2-one, or the compound
M.UN.X.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, I-1582); or
M.UN.X.6; a compound selected from the group of
M.UN.X.6a) (E/Z)—N-[1-[(6-chloro-3-pyridyl)methyl]-2-pyridylidene]-2,2,2-trifluoro-acetamide;
M.UN.X.6b) (E/Z)—N-[1-[(6-chloro-5-fluoro-3-pyridyl)methyl]-2-pyridylidene]-2,2,2-trifluoro-acetamide;
M.UN.X.6c) (E/Z)-2,2,2-trifluoro-N-[1-[(6-fluoro-3-pyridyl)methyl]-2-pyridylidene]acetamide;
M.UN.X.6d) (E/Z)—N-[1-[(6-bromo-3-pyridyl)methyl]-2-pyridylidene]-2,2,2-trifluoro-acetamide;
M.UN.X.6e) (E/Z)—N-[1-[1-(6-chloro-3-pyridyl)ethyl]-2-pyridylidene]-2,2,2-trifluoro-acetamide;
M.UN.X.6f) (E/Z)—N-[1-[(6-chloro-3-pyridyl)methyl]-2-pyridylidene]-2,2-difluoro-acetamide;
M.UN.X.6g) (E/Z)-2-chloro-N-[1-[(6-chloro-3-pyridyl)methyl]-2-pyridylidene]-2,2-difluoro-acetamide;
M.UN.X.6h) (E/Z)—N-[1-[(2-chloropyrimidin-5-yl)methyl]-2-pyridylidene]-2,2,2-trifluoro-acetamide and
M.UN.X.6i) (E/Z)—N-[1-[(6-chloro-3-pyridyl)methyl]-2-pyridylidene]-2,2,3,3,3-pentafluoro-propanamide.); or of the compounds
M.UN.X.7: 3-[3-chloro-5-(trifluoromethyl)phenyl]-4-oxo-1-(pyrimidin-5-ylmethyl)pyrido[1,2-a]pyrimidin-1-ium-2-olate; or
M.UN.X.8: 8-chloro-N-[2-chloro-5-methoxyphenyl)sulfonyl]-6-trifluoromethyl)-imidazo[1,2-a]pyridine-2-carboxamide; or
M.UN.X.9: 4-[5-(3,5-dichlorophenyl)-5-(trifluoromethyl)-4H-isoxazol-3-yl]-2-methyl-N-(1-oxothietan-3-yl)benzamide; or
M.UN.X. 10: 5-[3-[2,6-dichloro-4-(3,3-dichloroallyloxy)phenoxy]propoxy]-1H-pyrazole;
or
3) one antifungal biocontrol agent or plant bioactivator IC selected from the group consisting of:
L1) Microbial pesticides with fungicidal, bactericidal, viricidal and/or plant defense activator activity: Ampelomyces quisqualis, Aspergillus flavus, Aureobasidium pullulans, Bacillus amyloliquefaciens, B. mojavensis, B. pumilus, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus polymyxa, Pantoea vagans, Phlebiopsis gigantea, Pseudomonas sp., Pseudomonas chloraphis, Pseudozyma flocculosa, Pichia anomala, Pythium oligandrum, Streptomyces griseoviridis, S. lydicus, S. violaceusniger, Talaromyces flavus, Trichoderma asperellum, T. atroviride, T. gamsii, T. harmatum; T. harzianum, mixture of T. harzia [symbol] num and T. viride; mixture of T. polysporum and T. harzianum; T. stromaticum, T. virens (also named Gliocladium virens), T. viride, Typhula phacorrhiza, Ulocladium oudemansii, Verticillium dahlia, zucchini yellow mosaic virus (avirulent strain);
L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium or sodium bicarbonate, Reynoutria sachlinensis extract, salicylic acid, tea tree oil;
L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia sp., Chromobacterium subtsugae, Cydia pomonella granulosis virus, Cryptophlebia leucotreta granulovirus (CrleGV), Isaria fumosorosea, Heterorhabditis bacteriophora, Lecanicillium longisporum, L. muscarium (formerly Verticillium lecanii), Metarhizium anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramose, P. reneformis, P. thornea, P. usgae, Pseudomonas fluorescens, Steinernema carpocapsae, S. feltiae, S. kraussei;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Tagetes oil;
L5) Microbial pesticides with plant stress reducing, plant growth regulator, plant growth promoting and/or yield enhancing activity: Azospirillum amazonense A. brasilense, A. lipoferum, A. irakense, A. halopraeferens, Delftia acidovorans, Glomus intraradices, Penicillium bilaiae;
L6) Biochemical pesticides with plant stress reducing, plant growth regulator and/or plant yield enhancing activity: abscisic acid, aluminium silicate (kaolin), 3-decen-2-one, formononetin, genistein, hesperetin, homobrassinlide, humates, lysophosphatidyl ethanolamine, naringenin, polymeric polyhydroxy acid, Ascophyllum nodosum (Norwegian kelp, Brown kelp) extract and Ecklonia maxima (kelp) extract;
and
4) one compound II selected from jasmonic acid, salts or derivatives thereof.

23. The mixture according to claim 22 comprising compound IA and compound II.

24. The mixture according to claim 22 comprising compound IB and compound II.

25. The mixture according to claim 22 comprising compound IC and compound II.

26. The mixture according to claim 23 comprising as compound IA one fungicidal compound selected from azoxystrobin, dimoxystrobin, fluoxastrobin, kresoxim-methyl, orysastrobin, picoxystrobin, pyraclostrobin, trifloxystrobin, cyazofamid, amisulbrom, bixafen, boscalid, carboxin, fluopyram, fluxapyroxad, isopyrazam, penflufen, penthiopyrad, sedaxane, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide, ametoctradin, silthiofam, cyproconazole, epoxiconazole, fluquinconazole, ipconazole, metconazole, propiconazole, prothioconazole, tebuconazole, triadimenol, triticonazole, prochloraz, fenpropimorph, benalaxyl, benalaxyl-M, kiralaxyl, metalaxyl, hymexazole, carbendazim, thiabendazole, thiophanate-methyl, ethaboxam, metrafenone, cyprodinil, pyrimethanil, iprodione, dimethomorph, mancozeb, maneb, metiram, thiram, chlorothalonil, captan, dithianon, isotianil, tiadinil, prohexadione-calcium, triazoxide.

27. The mixture according to claim 23 comprising as compound IA one fungicidal compound selected from the group consisting of azoxystrobin, dimoxystrobin, fluoxastrobin, kresoxim-methyl, orysastrobin, picoxystrobin, pyraclostrobin, trifloxystrobin, amisulbrom, bixafen, boscalid, fluopyram, fluxapyroxad, isopyrazam, penflufen, sedaxane, N-[9-(dichloromethylene)-1,2,3,4-tetrahydro-1,4-methanonaphthalen-5-yl]-3-(difluoromethyl)-1-methyl-1H-pyrazole-4-carboxamide, ametoctradin, silthiofam, epoxiconazole, fluquinconazole, ipconazole, metconazole, prothioconazole, tebuconazole, triticonazole, prochloraz, fenpropimorph, metalaxyl, carbendazim, thiophanate-methyl, metrafenone, pyrimethanil, dimethomorph, mancozeb, metiram, dithianon, isotianil, tiadinil and prohexadione-calcium.

28. The mixture according to claim 23 comprising as compound IA one fungicidal compound selected from the group consisting of: azoxystrobin, coumethoxystrobin, coumoxystrobin, dimoxystrobin, enestroburin, fenaminstrobin, fenoxystrobin/flufenoxystrobin, fluoxastrobin, kresoxim-methyl, mandestrobine, metominostrobin, orysastrobin, picoxystrobin, pyraclostrobin, pyrametostrobin, pyraoxystrobin, trifloxystrobin and 2-(2-(3-(2,6-dichlorophenyl)-1-methyl-allylideneaminooxymethyl)-phenyl)-2-methoxyimino-N-methyl-acetamide, pyribencarb, triclopyricarb/chlorodincarb, famoxadone, and fenamidone.

29. The mixture according to claim 23 comprising as compound IA pyraclostrobin.

30. The mixture according to claim 24 comprising as compound IB one insecticidal compound selected from carbofuran, carbosulfan, methiocarb, methomyl, thiodicarb, triazamate, acephate, chlorpyrifos, chlorpyrifos-methyl, dimethoate, methamidophos, ethiprole, fipronil, 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, bifenthrin, cyfluthrin, beta-cyfluthrin, lambda-cyhalothrin, cypermethrin, alpha-cypermethrin, zeta-cypermethrin, deltamethrin, fenvalerate, flucythrinate, permethrin, tefluthrin, acteamiprid, chlothianidin, cycloxaprid, dinotefuran, flupyradifurone, imidacloprid, nitenpyram, sulfoxaflor, thiacloprid, thiamethoxam, the compound 1-[(6-chloro-3-pyridyl)methyl]-7-methyl-8-nitro-5-propoxy-3,5,6,7-tetrahydro-2H-imidazo[1,2-a]pyridine, spinosad, spinetoram, abamectin, emamectin benzoate, bacillus thuringiensis, bacillus thuringiensis subsp. israelensis, bacillus sphaericus, bacillus thuringiensis subsp. aizawai, bacillus thuringiensis subsp. kurstaki, bacillus thuringiensis subsp. tenebrionis, or Bt crop proteins: Cry1Ab, Cry1Ac, Cry1Fa, Cry2Ab, mCry3A, Cry3Ab, Cry3Bb, or Cry34/35Ab1, chlorfenapyr, diflubenzuron, flufenoxuron, lnovaluron, teflubenzuron, tebufenpyrad, indoxacarb, metaflumizone, flubendiamide, chloranthraniliprole (rynaxypyr), cyanthraniliprole (cyazypyr), the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid or (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, the compound 3-bromo-N-{2-bromo-4-chloro-6-[(1-cyclopropylethyl)carbamoyl]phenyl}-1-(3-chlorpyridin-2-yl)-1H-pyrazole-5-carboxamide (known from WO 2005/077934), the compound methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate, N2-[2-(3-chloro-2-pyridyl)-5-[(5-methyltetrazol-2-yl)methyl]pyrazol-3-yl]-5-cyano-N1,3-dimethyl-phthalamide and bacillus firmus strain “CNCM I-1582”.

31. The mixture according to claim 24 comprising as compound IB one insecticidal compound selected from the group consisting of thiodicarb, ethiprole, fipronil, lambda-cyhalothrin, alpha-cypermethrin, fenvalerate, permethrin, acteamiprid, chlothianidin, cycloxaprid, dinotefuran, flupyradifurone, imidacloprid, nitenpyram, sulfoxaflor, thiacloprid, thiamethoxam, spinosad, abamectin, emamectin benzoate, bacillus thuringiensis, bacillus thuringiensis subsp. israelensis, bacillus sphaericus, bacillus thuringiensis subsp. aizawai, bacillus thuringiensis subsp. kurstaki, bacillus thuringiensis subsp. tenebrionis, or Bt crop proteins: Cry1Ab, Cry1Ac, Cry1Fa, Cry2Ab, mCry3A, Cry3Ab, Cry3Bb, or Cry34/35Ab1, chlorfenapyr, flufenoxuron, teflubenzuron, metaflumizone, flubendiamide, chloranthraniliprole (rynaxypyr) and cyanthraniliprole (cyazypyr).

32. The mixture according to claim 25 comprising as compound IC one antifungal biocontrol agent or plant bioactivator selected from the group consisting of
L1) Microbial pesticides with fungicidal, bactericidal, viricidal and/or plant defense activator activity: Ampelomyces quisqualis M-10, Aspergillus flavus NRRL 21882, Aureobasidium pullulans DSM 14940, A. pullulans DSM 14941, Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens FZB42, B. amyloliquefaciens IN937a, B. amyloliquefaciens IT-45 (CNCM I-3800), B. mojavensis AP-209 (NRRL B-50616), B. pumilus QST 2808 (NRRL B-30087), B. pumilus GHA 181, B. solisalsi AP-217 (NRRL B-50617), B. subtilis CX-9060, B. subtilis GB03, B. subtilis GB07, B. subtilis QST-713 (NRRL B-21661), B. subtilis var. amyloliquefaciens FZB24, B. subtilis var. amyloliquefaciens D747, Candida oleophila I-82, C. oleophila O, C. saitoana, Clavibacter michiganensis (bacteriophages), Coniothyrium minitans CON/M/91-08, Cryphonectria parasitica, Cryptococcus albidus, Dilophosphora alopecuri, Fusarium oxysporum, Clonostachys rosea f. catenulata J1446 (also named Gliocladium catenulatum), Gliocladium roseum 321U, Metschnikowia fructicola NRRL Y-30752, Microdochium dimerum, Microsphaeropsis ochracea P130A, Muscodor albus QST 20799, Paenibacillus polymyxa PKB1 (ATCC 202127), Pantoea vagans C9-1, Phlebiopsis gigantea, Pichia anomala WRL-76, Pseudozyma flocculosa PF-A22 UL, Pythium oligandrum DV 74, Streptomyces griseoviridis K61, S. lydicus WYEC 108, S. violaceusniger XL-2, S. violaceusniger YCED-9, Talaromyces flavus V117b, Trichoderma asperellum T34, T. asperellum SKT-1, T. asperellum ICC 012, T. atroviride LC52, T. atroviride CNCM I-1237, T. gamsii ICC 080, T. harmatum TH 382, T. harzianum TH-35, T. harzianum T-22, T. harzianum T-39; mixture of T. harzianum ICC012 and T. viride ICC080; mixture of T. polysporum and T. harzianum; T. stromaticum, T. virens (also named Gliocladium virens) GL-21, T. virens G41, T. viride TV1, Typhula phacorrhiza 94671, Ulocladium oudemansii HRU3, Verticillium dahlia, zucchini yellow mosaic virus (avirulent strain);
L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium bicarbonate, Reynoutria sachlinensis extract, salicylic acid, sodium bicarbonate, tea tree oil;
L3) Microbial pesticides with insecticidal, acaricidal, molluscidal and/or nematicidal activity: Agrobacterium radiobacter K1026, A radiobacter K84, Bacillus firmus I-1582, B. thuringiensis ssp. aizawai strains ABTS-1857, SAN 401 I, ABG-6305 and ABG-6346, B. t. ssp. israelensis AM65-52, B. t. ssp. israelensis SUM-6218, B. t. ssp. galleriae SDS-502, B. t. ssp. kurstaki EG 2348, B. t. ssp. kurstaki SB4, B. t. ssp. kurstaki ABTS-351 (HD-1), Beauveria bassiana ATCC 74040, B. bassiana GHA, B. bassiana H123, B. bassiana DSM 12256, B. bassiana PPRI 5339, B. brongniartii, Burkholderia sp. A396, Chromobacterium subtsugae PRAA4-1, Cydia pomonella granulosis virus V22, Cydia pomonella granulosis virus V1, Isaria fumosorosea Apopka-97, Lecanicillium longisporum KV42, L. longisporum KV71, L. muscarium (formerly Verticillium lecanii) KV01, Metarhizium anisopliae FI-985, M. anisopliae FI-1045, M. anisopliae F52, M. anisopliae ICIPE 69, M. anisopliae var. acridum IMI 330189, Nomuraea rileyi strains SA86101, GU87401, SR86151, CG128 and VA9101, Paecilomyces fumosoroseus FE 9901, P. lilacinus 251, P. lilacinus DSM 15169, P. lilacinus BCP2, Paenibacillus popilliae Dutky-1940 (NRRL B-2309=ATCC 14706), P. popilliae KLN 3, P. popilliae Dutky 1, Pasteuria spp. Ph3, Pasteuria spp. ATCC PTA-9643, Pasteuria spp. ATCC SD-5832, P. nishizawae PN-1, P. penetrans, P. ramose, P. reneformis Pr-3, P. thornea, P. usgae, Pseudomonas fluorescens CL 145A, Steinernema carpocapsae, S. feltiae, S. kraussei L137;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, 2-methyl 1-butanol, methyl eugenol, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Tagetes oil;
L5) Microbial pesticides with plant stress reducing, plant growth regulator, plant growth promoting and/or yield enhancing activity: Azospirillum amazonense BR 11140 (SpY2T), A. brasilense AZ39, A. brasilense XOH, A. brasilense BR 11005 (Sp245), A. brasilense BR 11002, A. lipoferum BR 11646 (Sp31), A. irakense, A. halopraeferens, Glomus intraradices RTI-801, Penicillium bilaiae;
L6) Biochemical pesticides with plant stress reducing, plant growth regulator and/or plant yield enhancing activity: abscisic acid, aluminium silicate (kaolin), 3-decen-2-one, formononectin, genistein, hesperetin, homobrassinlide, humates, lysophosphatidyl ethanlamine, naringenin, polymeric polyhydroxy acid, salicylic acid, Ascophyllum nodosum (Norwegian kelp, Brown kelp) extract and Ecklonia maxima (kelp) extract.

33. The mixture according to claim 22 comprising as compound II jasmonic acid methyl ester.

34. The mixture according to claim 22 comprising as compound II jasmonic acid.

35. The mixture according to claim 22, wherein the ratio by weight is from 1:500 to 500:1.

36. A pesticidal composition, comprising a liquid or solid carrier and a mixture as defined in claim 22.

37. A method for controlling pests, wherein the pest, their habitat, breeding grounds, their locus or the plants to be protected against pest attack, the soil or plant propagation material are treated with a effective amount of a mixture as defined in claim 22.

38. A method for improving the health of plants, wherein the plant, the locus where the plant is growing or is expected to grow or plant propagation material from which the plant grows are treated with a effective amount of a mixture as defined in claim 22.

39. A method according to claim 37, wherein the resistance of the plant to abiotic stress is improved.

40. A method for protection of plant propagation material from pests comprising contacting the plant propagation materials with a mixture as defined in claim 22 in pesticidally effective amounts.

41. A method as claimed in claim 37, wherein the compounds are applied simultaneously, that is jointly or separately, or in succession.

42. Plant propagation material treated with the mixture as defined in claim 22 in an amount of from 0.01 g to 10 kg per 100 kg of plant propagation material.
